(19) United States
(12) Patent Application Publication
(10) Pub. No.: US 2011/0055770 A1
(43) Pub. Date: Mar. 3, 2011

(54) USER INTERFACE METHOD AND APPARATUS FOR A RESERVATION DEPARTURE AND CONTROL SYSTEM

(76) Inventors: Maria B. Hed, Eagan, MN (US); Tony M. Krusz, Burnsville, MN (US); Amy L. Meysembourg, Prior Lake, MN (US); Jeffrey M. Rogers, Mendota Heights, MN (US); Shirley A. White, Minneapolis, MN (US); Sandra J. Racine, Muskego, WI (US)

(21) Appl. No.: 12/550,608

(22) Filed: Aug. 31, 2009

(51) Int. Cl. G06F 3/048

(52) U.S. Cl. 715/854

(57) ABSTRACT

A user interface that may be adapted for use with a Reservation and Departure Control System (RDCS) for a transportation industry is disclosed. The RDCS manages the booking and re-booking of passengers on a transportation carrier. In one embodiment, the system supports a re-booking process wherein passengers whose travel accommodations (e.g., one or more airline flights) have been cancelled or modified are re-booked on different accommodations. The user interface is designed to graphically convey the flow, as well as the hierarchy, of the re-booking process to a user. This interface further includes links that naturally navigate a user from one process step to the next so that an in-depth knowledge of process flow is not required for successful use of the system.

### RELATED APPLICATIONS

The following Patent Applications, all of which were filed on even date herewith with the U.S. Patent and Trademark Office, have some subject matter in common with the current Application, and are incorporated herein by reference in their entirety:

“User Interface Method and Apparatus for a Reservation Departure and Control System”, U.S. application Ser. No. 11/003,281, filed on Dec. 3, 2004;

“An Airlines Booking System and Method that Utilizes Selectable Business Rules”, U.S. application Ser. No. 11/003,910 filed on Dec. 3, 2004;

“Automated System and Method for Booking a Customer to Receive a Service”; U.S. application Ser. No. 11/003,198 filed on Dec. 3, 2004;

“Network-Based Management of Airline Business Rules”, U.S. application Ser. No. 11/003,913 filed on Dec. 3, 2004; and

“Apparatus and Method for Minimizing Manual Intervention Within a Reservation Departure and Control System”, U.S. application Ser. No. 11/003,178 filed on Dec. 3, 2004.

### FIELD OF THE INVENTION

The present invention relates generally to a system and method for booking passengers on transportation carriers; and more particularly, to a user interface for re-booking passengers on carriers following the occurrence of a travel event that requires a change to one or more original reservations.

### BACKGROUND OF THE INVENTION

Transportation carriers such as airlines, trains, bus companies and the like generally employ some type of reservation and departure control system. Such systems are used to book passengers, track baggage, and manage departures and arrivals. These types of systems share a common need to rebook and/or reseat customers because of travel events. For example, commercial airlines are affected by travel events that include flight schedule changes, routing and equipment changes, flight delays or cancellations because of weather or some other reason, voluntary and involuntary denied boardings, or other similar occurrences. These events may occur prior to departing while a traveler is at an initial departure point, or while a traveler is enroute to a destination. For example, an event may occur while a traveler is enroute to a connection point that will affect the next leg of a journey.

Events such as those discussed above may affect the plans of many travelers. This is particularly true for carriers such as airlines that develop tight flight schedules to keep planes in the air as much as possible. The “hub and spoke” system used by most major airlines to maximize the number of city pairs served only accentuates the problem, since isolated events can have system-wide repercussions. For example, events that affect the operations at a hub location can alter the schedules at the spoke locations as well, leading to missed connections, lost luggage, and overall poor customer service. Hundreds, if not thousands, of passengers may be affected.

When such events occur, some mechanism is needed to rebook customers on another flight, and then notify them of the flight changes. Prior art mechanisms for performing these tasks are very rudimentary. Generally, a search will be performed to select one flight that will be used to re-accommodate all passengers that had been booked on the cancelled flight. As may be appreciated, this type of re-booking process is relatively straight-forward. An airline representative simply initiates a search to select a flight that will re-accommodate all inconvenienced passengers. All passengers are then re-booked as a group on that alternative flight as space permits. Because this re-booking process is not complicated, a streamlined Reservation and Departure Control System (RDCS) and associated user interface may be provided to support the tasks needed to re-accommodate passengers according to the prior art method.

Although the prior art system is relatively simple, it does not necessarily meet the needs of the passengers. Because all passengers are booked on the same alternate flight regardless of their individual requirements and preferences, many passengers are inconvenienced. For example, passengers may needlessly miss connecting flights, may be forced to unnecessarily travel through inconvenient connecting cities, may be forced to endure overnight stays, and etc.

In addition to the foregoing, prior art RDCS systems such as that described above do not incorporate the business model of the carrier into the re-booking process. For example, these prior art systems do not allow each carrier to programmably control how re-booking will be performed so that the carrier's best customers are re-accommodated first, and so on.

To best serve the needs of a carrier's passengers as well as the carrier itself, a more flexible system and method is required for re-booking passengers in a way that takes into account both the requirements of the passengers as well as the particular business model utilized by that carrier. By its very nature, this type of a system is more complex than the prior art systems that support the simplistic methodology of re-booking all customers to the same flight. Thus, a user interface is needed for the system that will facilitate an understanding of the improved process. Ideally, this interface will allow a user to navigate between display screens in a manner that corresponds with process flow, and does not require the user to navigate between screens unnecessarily to obtain desired information.

### SUMMARY OF THE INVENTION

The current system and method provides a user interface that may be adapted for use with a Reservation and Departure Control System (RDCS) for a transportation carrier such as an airline. The RDCS is used to re-accommodate passengers after a weather-related occurrence, an equipment change, or any other event that requires passengers to be moved from one accommodation (e.g., flight) to another by the transportation carrier.

According to an embodiment of the RDCS that may be employed within the airlines industry, when passengers must be re-booked from one flight to another, RDCS 114 creates a Re-Booking Activity IDentifier (RAID). This RAID is a data structure that contains information about the re-accommodation activity, including an identification of the one or more original flights that must be re-accommodated. After a RAID is created, a guide is generated for the RAID. The guide lists all of the possible flights that may be used to re-accommodate the passengers that were originally scheduled to travel on the flight(s) associated with the RAID.

After a guide is generated, all of the passengers affected by the cancelled flights must be re-accommodated. In one embodiment, the system applies a set of business rules that will select from among the flights in the guide to obtain the flight that best re-accommodates each of the passengers. The flight selected to re-accommodate one passenger is not necessarily the same flight selected for a different passenger. The flights are selected based on passenger requirements, preferences, and other factors associated with the passenger's original booking. This selection process may largely be completed automatically through the use of programmable business rules that are defined by the airline to conform to its business model.

As affected passengers are re-booked on alternative flights in the foregoing manner, results are generated that list where and how each of the passengers is being re-booked. An agent may review these results, and if one or more of the re-accommodation arrangements are not satisfactory, the agent may generate a new guide for these passengers and repeat the process until acceptable arrangements are obtained.

As may be appreciated from the above description, the re-accommodation process may be thought of as having several steps, or functions. First, a new RAID is defined, or a previously-defined RAID may be selected. For that RAID, status may be viewed to determine the re-accommodation progress, if any, that has been made for the flights that were added to the RAID. Next, a guide is defined for the RAID, and is applied to the affected passengers such that some or all of the passengers will be re-accommodated on different flights. An agent may then wish to view these RAID results, which lists the flights selected to re-accommodate the passengers. If some of these re-accommodations are not considered acceptable, an input function is employed to update the guide, and the process is repeated for the bookings that are not acceptable. This process therefore includes the primary steps of RAID Selection, RAID Status, RAID Guide, RAID Results, and RAID Input.

For each of the five primary steps discussed above, a user may wish to review and operate on data for that step using various levels of detail. At the most general level, a user may wish to view data for one or more of the “affected” flights that have been affected by some event (e.g., a weather event such as a storm), and which have been subsequently associated with the RAID for re-accommodation. At a more specific level of detail, the user may wish to view details regarding the one or more “affected” flight segments that are included in an affected flight. Finally, for each of the affected segments, the user may wish to view and/or update the list of alternate segments that are available to re-accommodate the particular affected segment. These three levels of detail exist for at least some of the primary functions discussed above. For instance, during the Guide step, guide data may be viewed at the Affected Flight, Affected Segment, and Alternate Segment levels. This is likewise true for the Results step.

To summarize, the RDCS system and process of the current invention may be conceptualized as hierarchical. At the highest level, the process consists of the primary steps of RAID Selection, Status, Guide, Results, and Input. At a lower level of the hierarchy, sub-functions, or sub-steps, exist that include Affected Flights, Affected Segments, and Alternate Segments. The current user interface visually conveys this hierarchy by associating user-selectable tabs with each of the five primary steps or functions. These tabs are positioned near the top of the display screens above tabs corresponding to the Affected Flights, Affected Segments, and Alternate Segments sub-functions, or sub-steps. The tabs are oriented to visually represent the primary steps in the process, and the way in which each step relates to the sub-functions, or sub-steps.

In addition to the foregoing, the arrangement of the tabs from left-to-right serves to convey the flow of the re-booking process. For example, the five tabs associated with the high-level function are arranged in a left-to-right manner to convey the typical way in which the steps are executed, with the user starting at the left-most tab and working towards the right during execution of the process. Similarly, the tabs associated with the sub-functions or sub-steps are arranged in left-to-right manner from the Affected Flights and Affected Segments, to the Alternate Segments tab. By selecting these tabs in a typical left-to-right manner, the user is guided from the highest level of detail to the most granular detail level, which supports the typical process flow.

The current invention further provides navigational links to direct the user from one screen to the next according to the natural process flow. That is, by selecting an item displayed on an Affected Flights screen, the user is linked to an Affected Segments screen for the selected item. As discussed above, this is the next lower level of detail, and contains information typically desired after viewing the Affected Flights information. Similarly, by selecting an item displayed on the Affected Segments screen, the user is linked to an Alternate Segments screen for the item. In this manner, the user is guided to progressively more detailed views of the data. This occurs automatically so that the user need not necessarily understand the intricacies of the process, or the way in which the tabs correspond with detail levels.

As discussed above, the system may be viewed as hierarchical, with the five primary functions, or steps, being at a highest level. At a next lower level are the three remaining sub-functions that correspond to at least some of the primary functions. The three sub-functions may, in themselves, be viewed as hierarchical. At the top level in the hierarchy, the Affected Flights function provides all of the flights included in a RAID. The Affected Segments function provides all of the segments in a selected affected flight. The Alternate Segments function provides all of the alternate segments available for a selected affected segment.

The current system provides a mechanism to allow a user to view all data existing at a selected level in the hierarchy without having to traverse to another level. This is accomplished by linking screens within a particular hierarchical level. For example, once a user has navigated to an Affected Segment screen, the user may continue to view Affected Segments for not only a currently selected flight, but for other flights in the RAID as well. This is accomplished by employing “Previous Flight” and “Next Flight” links that are provided within the Affected Segment screen. This eliminates the need to traverse to a higher level in the information hierarchy, re-select a flight, than once again return to the Affected Segments screen. Similar capabilities are provided at the Affected Flights and Alternate Segments level of detail.

The current application also allows the user to easily understand the way in which RAIDs are related. One or more (child) RAIDs may have an interdependency on a previously-created (parent) RAID, which may, in turn, have another interdependency on still an earlier-created RAID. Thus, a family of RAIDs may exist in this manner. To allow a user to easily visualize the way in which RAIDs are related, a numbering scheme is utilized that assigns each child RAID the same identifier as its parent, and further assigns a unique post-fix that distinguishes the child from the parent and other children. This establishes a “family tree” of RAIDs that can be readily tracked and managed. A family of RAIDs may be viewed using a Related RAIDs capability supported by the system and method of the current invention.

Finally, another utility allows a user to “book-mark” a particular RAID as the current “In-Progress” RAID. This function is useful since, while re-accommodating a current RAID, a user may have to review information from other related RAIDs. Rather than requiring the user to remember the alphanumeric identifier associated with that current RAID for use in returning to the screens for that RAID at a later time, the user may merely use the In-Progress RAID Function to book-mark that RAID. At any time thereafter, the user may return to the screens for the book-marked RAID by selecting the In-Progress RAID function. In this manner, the user need not remember the identifier assigned to the current RAID.

According to one embodiment of the invention, a user interface is described that supports a process that has multiple steps. These steps are performed with the aid of a data processing system. The user interface includes means for providing one or more display screens each having multiple screen areas. Each of the screen areas is associated with a respective one of the steps of the process. The screen areas are spatially arranged to graphically convey an order in which the steps are performed. The user interface further includes means for arranging, within at least one of the user screens, at least some of the screen areas in a manner that graphically conveys a hierarchical relationship between one or more of the steps and one or more other ones of the steps. In one implementation of this embodiment, the screen areas are the various user-selectable tabs. The hierarchical relationships include those relationships between the Affected Flight, Affected Segment, and Alternate Segment sub-steps and the primary RAID List, Status, Guide, Results and Input steps.

According to one aspect of the foregoing embodiment, multiple instances of the process may be in-progress at once time, each corresponding to a respective data instance, which in this implementation is a RAID. Means are provided for allowing a user to specify one of the data instances (i.e., RAIDs) as an in-progress instance. Additional means are provided for allowing a user to navigate to screens describing the in-progress instance.

In another embodiment, an automated method of interacting with a user that is performing a process supported by a Reservation and Departure Control System (RDCS) is described. The method includes providing the capability to generate multiple display screens, each of the display screens for aiding in completion of an associated step in the process. Each of the display screens includes first screen regions that each corresponds to a respective one of the steps. The screen regions are spatially arranged to convey to a user an order in which the steps are typically executed. Selection of any of the first screen regions, which includes the user-selectable tabs for the primary functions or steps, results in the generation of a respective one of the display screens for a currently-selected step.

The method further includes providing, within at least one of the display screens, multiple second screen regions. The second screen regions are spatially positioned to convey that each of these regions represents a respective sub-step for one or more of the steps. Selection of any of the second screen regions, which includes the user-selectable tabs for the sub-functions or sub-steps, results in generation of a respective one of the display screens. The newly generated screen aids in completion of the respective sub-step for the currently-selected step.

According to one aspect of the foregoing method, additional steps may include allowing a user to select one of the second screen regions, and generating a respective display screen for the selected second screen regions. The respective display screen includes multiple selectable instances on which the respective sub-step may be performed. For example, within an Affected Flights screen, multiple instances of affected flights may be listed. As another example, within an Affected Segments screen, multiple instances of affected segments may be listed. The user may then select one of these instances. In response to this selection of an instance, a respective display screen is generated to allow a sub-step that is typically performed next in the process to be executed on the selected instance. For example, in an Affected Segments screen for a Guide, a user may select any one of listed Affected Segments. This selection results in generation of a display to allow the Alternate Segments to be chosen for the selected Affected Segment.

In another embodiment, the invention comprises an automated method of providing a user interface for a data processing system that controls a process. The method includes providing functions that are each associated with the process, wherein each of the functions is represented by a respectively associated user-selectable area of a display screen. The method further includes providing multiple sub-functions that are associated with one or more of the functions, wherein each of the sub-functions is represented by a respectively associated user-selectable area of the display screen. The method also comprises arranging the user-selectable areas within the display screen to graphically convey the order in which the functions and sub-functions are typically executed during the process, and to further indicate how the sub-functions interrelate to the functions.

It will be appreciated by those skilled in the art that the concepts described herein, while discussed in terms of a Reservation and Departure Control System for an airline, may be equally applied to any other type of RDCS used in any transportation industry. Moreover, these concepts may be readily adapted for use in any user interface employed to control any process related to any other data processing application, a manufacturing process, or a process used in yet another environment. This will be discussed further below in reference to the above-mentioned and other aspects of the current system and the applicable drawings.

### BRIEF DESCRIPTION OF THE DRAWINGS

FIG. 1 is a block diagram of an exemplary data processing system that may usefully employ the current invention.

FIG. 2 is a logic block diagram of an exemplary embodiment of a Reservation and Departure Control System (RDCS) that may utilize the current invention.

FIGS. 3A and 3B, when arranged as shown in FIG. 3, are a more detailed block diagram of the Re-booking Module of the Reservation and Departure Control System.

FIG. 4 is a diagram of a screen provided by a user interface for the Reservation and Departure Control System (RDCS).

FIG. 5 illustrates a Find RAIDs screen.

FIG. 6 illustrates a screen provided upon activation of the Find_RAIDs function.

FIG. 7 illustrates a RAID Status screen.

FIG. 8 illustrates a RAID Guide screen for Affected Flights.

FIG. 9 illustrates a RAID Guide screen for Affected Segments.

FIG. 10 illustrates a RAID Guide screen for Alternate Segments.

FIG. 11 illustrates a RAID Results screen for Affected Flights.

FIG. 12 illustrates a RAID Results screen for Affected Segments.

FIG. 13 illustrates a RAID Results screen for Alternate Segments.

FIGS. 14A and 14B, where arranged as shown in FIG. 14, illustrates a RAID Input screen.

FIG. 15 is a flow diagram illustrating the assigning of RAID identifiers in a manner that allows a user to understand interdependencies existing between RAIDs.

### DETAILED DESCRIPTION OF THE DRAWINGS

### I. Description of an Exemplary Reservation and Departure Control System

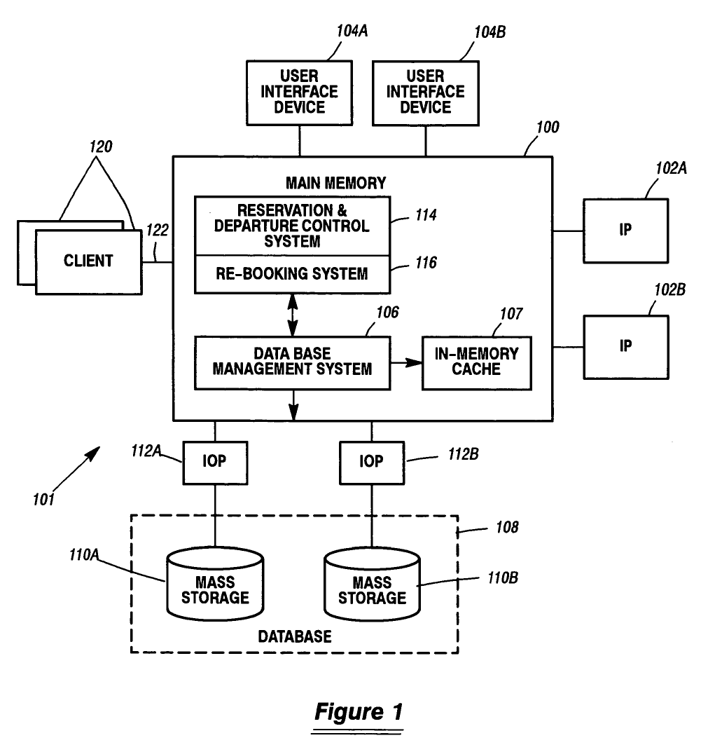

FIG. 1 is a block diagram of an exemplary data processing system 101 that may usefully employ the current invention. The data processing system may be a personal computer, a workstation, a legacy-type system, or any other type of data processing system known in the art. The system includes a main memory 100 that is interactively coupled to one or more Instruction Processors (IPs) 102a and 102b.

The memory may also be directly or indirectly coupled to one or more user interface devices 104A and 104B, which may include dumb terminals, personal computers, hand-held devices such as Personal Data Assistants (PDAs), workstations, sound or touch activated devices, cursor control devices such as mice, printers, or any other known device used to provide data to, or receive data from, the data processing system. These user interface devices 104A and 104B may be located at the same site as the main memory 100 and IPs 102A and 102B, or may be located remotely. For example, these user interface devices may be personal computers or workstations that are coupled via the Internet, an intranet, a Local Area Network (LAN), Wide Area Network (WAN), a wireless network, and the like. In one embodiment, these devices interact with data processing system 101 via a web browser in a client/server type environment.

A DataBase Management System (DBMS) 106 is loaded into main memory 100. This DBMS, which may be any DBMS known in the art, manages, and provides access to, a database 108 (shown dashed). The database may be stored on one or more mass storage devices 110a and 110b. Mass storage devices may be hard disks or any other suitable type of non-volatile or semi non-volatile device. These mass storage devices may be configured as a Storage Area Network (SAN), a Redundant Array of Independent Disks (RAID), or any other type of configuration. Battery back up may be provided, if desired. The transfer of data between mass storage devices and DBMS is performed by Input/Output Processors (IOPs) 112a and 112b.

A Reservation and Departure Control System (RDCS) 114 is coupled to DBMS 106. This system performs all of the reservation and check-in functions for a carrier such as an airline. According to the current invention, system 114 includes a re-booking module 116. The re-booking module initiates and manages all passenger-related activities that must be performed because a flight re-scheduling event makes it necessary to change original transportation plans. In particular, re-booking module 116 runs impact analyses to determine if schedule changes, flight equipment changes, delays, cancellations, misconnects, or any other type of irregular occurrence will affect customer bookings, check-in, seat assignments, baggage, travel documents, and/or travel plans. The system further manages the activities required to re-accommodate all affected customer bookings, including the re-adjustment of inventories, seat re-assignments, the updating of applicable travel documents and customer and flight information, and the generating of messages to provide adequate notifications. These activities are performed automatically through the use of business rules tailored to the requirements and business model of an individual airline, as is discussed further below.

RDCS 114 formats queries for data stored within database 108. These queries are passed to DBMS 106, which retrieves data records from, and stores data records to, the database 108. Such data includes both passenger and carrier data. In one embodiment, some of the data records retrieved from database 108 may be cached temporarily in an in-memory cache 107 to allow DBMS 106 to access the data more quickly.

As previously described, the system of FIG. 1 may support a client/server environment. In this case, one or more user interface devices such as personal computers, PDAs, and workstations serve as clients 120 that are coupled to data processing system 101 via a network 122, which may be the Internet, an intranet, LAN, WAN, or any other type of network known in the art. Some, or all, of the one or more clients 120 may be located remotely from data processing system 101. These clients may access RDCS via software such as a browser. Client-side software modules may execute on these clients, as will be discussed further below. Such client-side software may include Active X components or Java scripts executed by web browsers.

In one embodiment, clients 120 are coupled to RDCS via a web server (not shown in FIG. 1) that provides a web-based interface to the clients. This web server provides a seamless, network-based interface by which remote users access the RDCS. In one configuration, this web server may execute web server software such as the software marketed by Microsoft Corporation under the trade designation “INTERNET INFORMATION SERVER”.

It will be appreciated that the system of FIG. 1 is merely exemplary, and many other types of configurations may usefully employ the current re-booking system. For example, RDCS may be dispersed across multiple servers that are inter-coupled via a network. This is discussed further below.

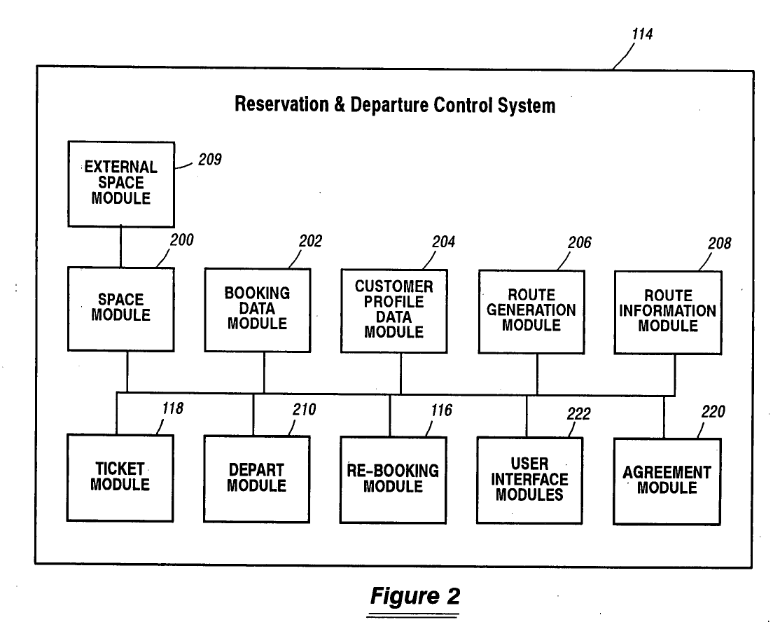

FIG. 2 is a logic block diagram of an exemplary embodiment of Reservation and Departure Control System 114 that may utilize the current invention. Although the following discussion focuses on the system as used by an airline, it will be understood that the system may be adapted for use by any other transportation carrier. Each of the blocks of FIG. 2 represents a respective system module, with the modules being communicatively coupled to share data. These modules may be implemented in software, firmware, any other type of programmed logic, hardware, or any combination thereof. In one embodiment, one or more of these modules is implemented in object-based technology, with inter-module communication being accomplished via messaging.

RDCS 114 includes a space module 200 to control and track the space available on the flights provided by the current carrier. When a customer is planning a journey, this module is used to determine which flights have space available to accommodate that trip. This module may also track the space available on flights provided by alliance partners and code-share partners of the current carrier. An alliance partnership is an arrangement whereby two or more airlines agree to consider one another's customers in a favorable manner according to the terms of a partnership agreement. Code-share partners are two airlines that have entered into an arrangement whereby each airline considers all of the code-share partner's routes as its own routes for booking purposes.

Information about the various relationships that have been established between the current airline and any other airline is maintained in agreements module 220. This module stores the terms and conditions of the various agreements that establish the code-share and alliance partnership relationships.

Space module 200 may be coupled to an external space system 209. The external space system supplies information about space available on flights provided by carriers besides the current carrier and its partners. If the current carrier or its partners cannot provide a flight that can accommodate a customer, RDCS 114 may seek to locate a suitable flight from external space module 209, as will be discussed below.

RDCS 114 further includes a booking data module 202 that receives and manages the booking data associated with airline flights. Booking data is defined as all of the information about a passenger or a group of passengers traveling together on the same journey. Such information includes passenger names, the number of segments in the journey, the routes (which for an airline includes the flight numbers), and any special needs and requirements such as special meals, wheelchairs, etc. that may be needed by one of the members in the party. It may further include car rental and hotel information, the manner in which the passengers are being ticketed, data regarding travel documents, contact and payment information, and information regarding any other accommodation or service associated with the journey. For example, the system may store information indicating the customer is to receive flowers at his hotel room, that the customer has booked tickets for a show, that the customer requires limousine service, and etc.

Customer profile data is managed by customer profile data module 204. This module obtains and stores all information about a given customer, including customer preferences regarding seat assignments, meals, preferred connection points, connection points that are to be avoided, and a preferred maximum number of flight connections per journey, hotel and vehicle preferences, preferred methods of payment and so on. The information may further provide contact information, including the preferred modes of communication, special customer needs and requirements such as handicap needs or whether the traveler is an unaccompanied minor, and information regarding loyalty programs in which the customer participates such as frequent flier plans. Such information may include the ways in which a customer would like to be compensated in the event he is inconvenienced by the carrier and becomes eligible for some type of compensation program. History information may also be provided, including whether, and the manner in which, a customer has been inconvenienced by the carrier in the past. This information may be used to provide automatic upgrades and/or discounts the next time the customer books transportation.

Other modules in system 114 include route generation module 206, which determines the route options that are available when traveling to a given destination. Depart module 210 manages the check-in process on the day of departure, including the check-in of both passengers and luggage. This module provides seat assignments, handles the issuance of boarding passes and bag tags, and manages standby passengers. Ticket module 118 controls the issuance of tickets.

RDCS further includes route information module 208, which obtains and manages the data describing upcoming flights. Such data includes departure and arrival times and locations, the aircraft assigned to a given flight, information on fare classes, sales restrictions, and information regarding the class of services provided by a flight. Other data managed by route information module includes ticket sales restrictions, a description of on-board amenities, and any other information that is maintained on a particular flight. Information module 208 may store and manage information for flights provided by the current carrier, as well as flights provided by carriers that are considered alliance partners and code-share partners of the current carrier.

RDCS 114 further includes re-booking system 116. Following an event such as a schedule change, equipment change, delay in arrival or departure, cancellation, misconnection, a route change, or any other type of irregular occurrence, the re-booking system supports the re-accommodation process to re-book passengers on alternative flights.

The system further includes one or more user interface modules 222 to allow users to interact with RDCS 114. These modules may include Active Server Pages, web pages written in HyperText Markup Language (HTML) or dynamic HTML, Active X modules, Java scripts, Java Applets, Distributed Component Object Modules (DCOM), and the like. User interface modules 222 may be downloaded onto one or more of clients 120 as “client-side” user interface modules to be discussed further below.

According to the current invention, re-booking system 116 supports the re-accommodation process in a manner that can be tailored to the business model of an individual airline. This is accomplished through the use of programmable business rules that are defined by the user of the system when that system is configured. The user selects rules, parameters, and reference data during this configuration process to govern how the system will operate.

According to one embodiment, the selection of business rules is performed using an extensive menu that provides choices regarding virtually every conceivable operational aspect of the system. By merely selecting the appropriate rules, the carrier is allowed to easily tailor the system to operate in accordance with its business philosophy. For example, for airlines that specialize in long-haul routes, the system may be configured to re-book long-haul customers first, thereby promoting the satisfaction of the customer base. Alternatively, the carrier may cater to business class customers, who are therefore favored during the re-booking process. In still another scenario, customers traveling with children or that have a special requirement (e.g., passengers requiring a wheel chair) may receive highest priority in the re-booking process. As yet another example, a carrier may desire to favor its high-value customers, where such customers may be those that travel frequently, purchase first-class or business-class tickets, and etc. The factors that make a customer “high-value” may be selected by the airline using the business rules. Conversely, if the airline is a single-class carrier, the system may be configured to operate without any prioritization. These selections may be easily changed as the business model of the airlines changes.

Re-booking module 116 provides significant benefits over prior art systems that are “hard-coded”. Prior art systems provide a single, inflexible approach for handling the re-booking procedure that cannot readily be changed to address the individual needs and requirements of a particular airline. Airline users of such prior art systems must pay the vendor to update the software that supports the system if specialized operations are required. This may be time-consuming and expensive. This type of customization may further result in support issues, since the system vendor must now maintain non-standard code modifications.

### II. Description of an Exemplary Re-Booking Module

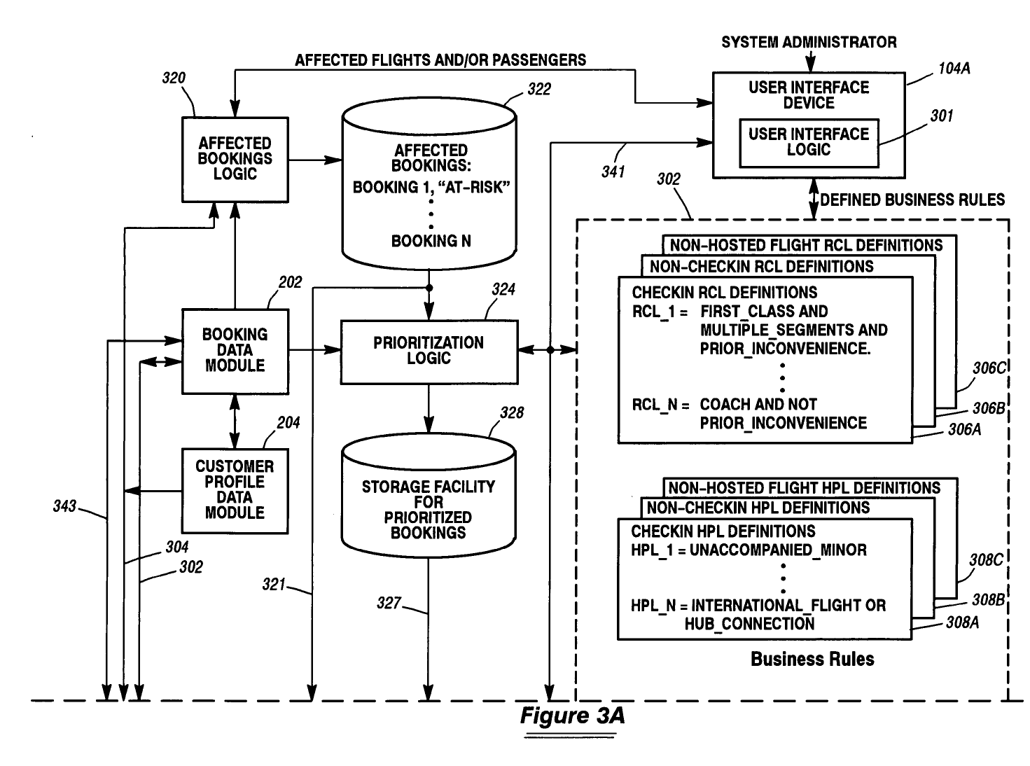

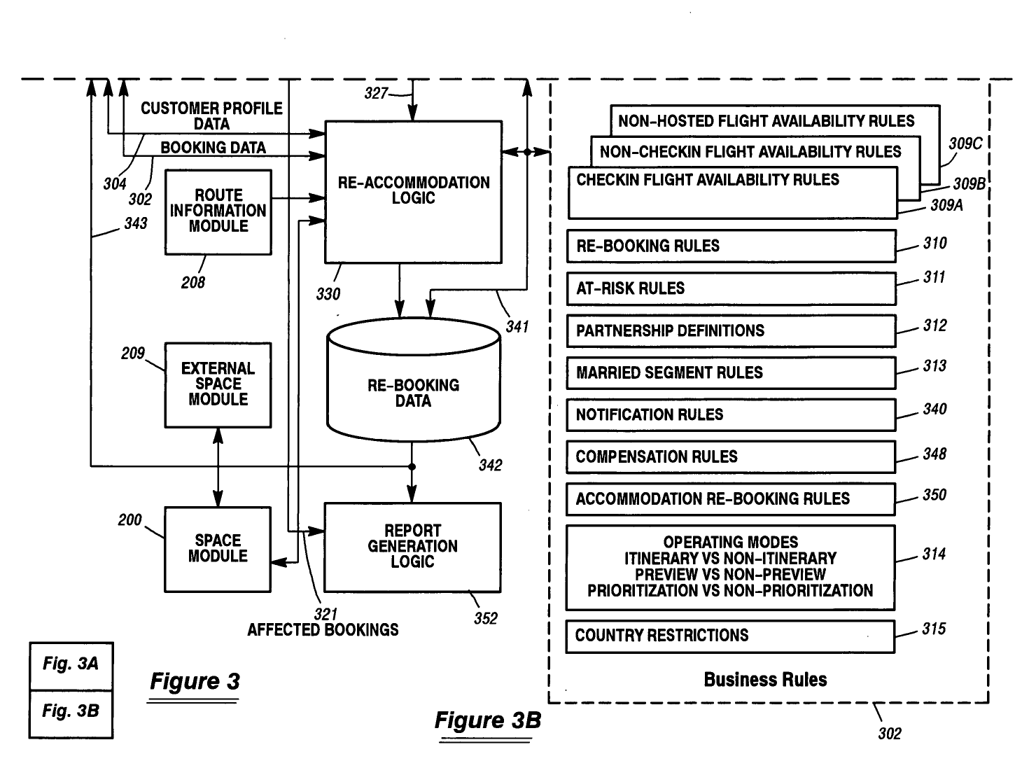

FIGS. 3A and 3B, when arranged as shown in FIG. 3, are a more detailed block diagram of the Re-booking Module 116. An embodiment of the system used by an airline will be described, although it will be understood that the system may be adapted for use by any other type of transportation carrier.

As discussed above, users interact with Re-booking Module 116 via user interface devices 104A and 104B, which may be personal computers, workstations, terminals, or any other similar devices known in the art. These user interface devices may be remotely located from RDCS. For example, they may be coupled to main memory 100 via any type of a network that may include the Internet or an intranet. When the system is employed within an airline environment, the user interface devices are typically located at an airport, although they may be located at other locations, such as within a hotel, a travel agency, or some other local staffed by the airline, or a person acting on behalf of the airline. As discussed above, user interface devices may operate as clients within a client/server environment. In this embodiment, these devices may access RDCS via a web server, for instance.

The user interface devices provide functions and display screens in accordance with user interface logic 301 and user interface modules 222, either of which may be implemented in software, firmware, and/or hardware. User interface logic 301 may include software that is downloaded from RDCS as client-side user interface modules. This logic may include Active X components or Java scripts executed by web browsers operating on the user interface devices. This logic will be described further below in a detailed discussion of the invention.

User interface logic 301 and user interface modules 222 provides a menu-driven user interface that allows users of RDCS 114 to define programmable business rules that control the manner in which re-booking activity will be performed. For the current discussion, a “user” of the system is an airline generally, and in particular, includes authorized airline employees such as ticketing agents or other agents associated with, or acting on behalf of, the airline. In a preferred embodiment, the ability to define business rules is a protected function that may be password protected or otherwise associated with a limited subset of user identification (user id) codes. Definition of these rules is initially performed during configuration of the system. Appropriate airlines personnel may then modify the initially-defined business rules at any time based on operational and policy changes of the airline.

Many types of business rules 302 (shown dashed) may be defined by the carrier and used during the re-accommodation process. In the exemplary embodiment of FIG. 3, these rules include Re-accommodation Complexity Level (RCL) definitions 306A-306C, Handling Priority Level (HPL) definitions 308A-308C, flight availability rules 309A-309C, re-booking rules 310, at-risk rules 311, partnership definitions 312, married segment rules 313, operating modes 314, notification rules 340, compensation rules 348, and accommodation rebooking rules 350. Other business rules that are beyond of the scope of the current application may also be defined as described in more detail in the commonly-assigned patent applications referenced above.

Next, the way in which re-booking module 116 is used to re-accommodate travelers is considered in more detail. A customer may initially interact with RDCS 114 by booking one or more flights with an airline. This reservation may be made by phone, Internet, by otherwise contacting an airline representative, or some other method. Booking data module 202 is responsible for collecting, organizing, and storing the data associated with the booking. As discussed above, this data, may be stored within database 108. Such data may describe whether one or more passengers are traveling together, whether one or more flights were involved in the travel arrangements, the type of tickets purchased (e.g., first class, business class, coach, etc.), whether any special services such as a wheel chair were requested, whether the flight reservations were made pursuant to a loyalty plan such as a frequent flier program, and etc. This data may be described as “booking data”, or simply as a “booking”.

Sometime after the booking is made, some event may occur that will require the booking to be re-accommodated. This may occur, for example, because of a weather event, an equipment problem, or some other occurrence that causes a flight cancellation, or causes passengers to be moved from one flight to another. This may further occur because a passenger misses a flight, or because of a flight delay that will result in one or more missed connections.

When any of the foregoing types of events occur, re-booking module 116 is employed to perform the re-accommodation activities. This module, which may be implemented in hardware, software, firmware, any other programmed logic, or any combination thereof, includes affected bookings logic. Affected bookings logic 320 receives an indication of the flight(s) and/or the individual passengers that are affected by the event. This information may be supplied manually by an airline agent, for example. In response, affected bookings logic 320 creates a Re-Booking Activity IDentifier (RAID) that lists the flight(s) that will be re-accommodated. This RAID is a data structure that will be used to track the re-accommodation activity that will occur with respect to these flights.

Next, the information regarding the affected flights and/or individual passengers affected by the event is used to access the booking data module 202 to determine which of the existing bookings are associated with these flights and/or passengers. For instance, in the case of a cancelled flight, a flight number is provided to affected bookings logic 320. Affected booking logic 320 retrieves booking data for each passenger booked on that flight. This includes all passengers that are starting their journey on that flight, as well as any passengers that are initially traveling on another flight and are thereafter connecting with the affected flight.

In one embodiment, affected bookings logic 320 further takes various other data into account when determining which flights will be affected by an event. For example, certain married segment rules 313, which are part of business rules 302, define relationships between two or more flights that are thereby considered “married”. If one of a group of married flights is cancelled, all of the flights in that group must also be cancelled, and the bookings originally scheduled on all of those flights must be re-accommodated. Therefore, if married segment rules 313 are enabled, the cancellation of one flight may affect bookings associated with other flights as well.

After affected bookings logic 320 has determined which bookings must be re-accommodated, that list is stored within main memory 100, within database 108, or some other storage facility associated with the system. Operation next continues in a manner that is based on the configuration of operating modes 314 as selected by the user. If a prioritization mode is enabled, prioritization logic 324 will prioritize the list of affected booking entries 322 using RCLs 306A-306C and HPLs 308A-308C. The bookings are then re-accommodated in an order based on their assigned priority. The way in which this prioritization occurs is largely beyond the scope of this application, and is described in the commonly-assigned patent application entitled “An Airlines Booking System and Method that Utilizes Selectable Business Rules”, referenced above. If prioritization mode is disabled, this step may be omitted from the process.

Next, the bookings are processed by re-accommodation logic 330 of FIG. 3B. If prioritization mode is enabled, the bookings are re-accommodated based on their respective priority. Otherwise, they are processed in the order in which they were added to the list of affected bookings 322. During this processing, flight availability rules 309A-309C are employed to select a list of flights that will be considered for use in re-accommodating the bookings. This list of alternative flights is referred to as a “guide”. Each guide is associated with the RAID that it is re-accommodating, as will be discussed further below.

As discussed above, flight availability rules are used to select the flights that are added to the guide. These rules consider such things as the times, dates, and routes of available flights, the carriers that are providing these flights, whether the flights are overbooked, the types of tickets and seats remaining to be booked for a given flight (e.g., first class, business, coach), the cost of each flight, the number of segments in the flight, and etc. Flight availability rules may further take into account business relationships that have been formed between a current carrier and other carriers, as are defined by partnership definitions 312.

The information utilized by flight availability rules is obtained from the various modules of the system of FIG. 2, including space module 200, which provides information regarding the space that is available on a given flight provided by the current carrier, and external space module 209, which provides information on space available on flights provided by other carriers. Flight availability rules also utilizes data provided by route information module 208, which organizes and manages the data describing all departure and arrival times and locations of upcoming flights provided by the current carrier and, in some embodiments, one or more other carriers.

Consider an example wherein a guide is being created for a cancelled flight that had been scheduled to fly between points A and B. In a very simple scenario, one or more of the flight availability rules may be defined to select as alternative flights all flights that fly from point A to point B and arrive at point B within a predetermined time of when the original flight was scheduled to arrive. This sub-set of candidate flights may be further narrowed to those provided by the current carrier and one or more of the current carrier's business partners, for example. In yet a more complex scenario, this sub-set may further be narrowed to those that have, at most, two flight segments between points A and B. Of course, flight availability rules may be much more complex, taking into account many more variables.

In the foregoing manner, the guide may be populated with a set of candidate flights that is selected by flight availability rules 309A-309C, which may be written as Boolean equations that take into account various characteristics concerning available alternative flights.

After all candidate flights that are selected by the flight availability rules are added to the guide, the flights may be ordered according to programmable criteria selected by flight availability rules. For example, the flights may be ordered based on arrival times at the destination point, based on the number of segments in the flight, or some other criteria. The flights are considered in this order when determining which flight to use to re-accommodate a particular booking, as will be discussed below. This newly-created guide may then be displayed to an airline agent for approval. At this time, the agent may add flights to, or delete flights from, the guide, and may further re-order the flights. Alternatively, the agent may merely approve the guide as it was created by the flight availability rules.

After guide creation is completed, a second stage in the re-accommodation process is initiated. In this stage, an attempt will be made to re-book each of the bookings affected by the event on the one of the flights in the guide that best satisfies the requirements of that particular booking. It will be appreciated that the flight that is best for one booking is not necessarily the same flight that is best for another booking. This re-accommodation process will take into account customer preference data stored in customer profile data module 204, any special requests made by passengers (e.g., access to a wheel chair, help for an unaccompanied minor, etc.), as well as other data associated with the booking. Other considerations involve country restrictions 315 that determine whether persons of some nationalities are restricted when traveling within other countries. Based on this and other criteria, re-accommodation logic 330 will attempt to select a best flight from the guide for use in re-accommodating a particular booking.

If the above-described process cannot locate a flight that will re-accommodate the passenger(s) associated with a particular booking, as may occur if all flights in the guide will cause the passenger(s) to miss a subsequent connecting flight, re-accommodation logic 330 automatically attempts to re-accommodate the booking using an itinerary mode that disregards connection points. This is largely beyond the scope of the current invention, and is described in detail in the patent application entitled “An Airlines Booking System and Method that Utilizes Selectable Business Rules”, referenced above. If this mode also fails to locate a satisfactory flight alternative, the booking is flagged for review by an agent, who may then manually re-book the flight. Alternatively, the agent may update the guide to include additional flights, and then re-process the bookings using the new guide.

In the foregoing manner, passengers are re-booked to a “best fit” flight based on customer preference and requirements data. When the re-booking is completed, the original booking will generally be cancelled, unless the original flight is considered “at risk”, meaning it is unknown whether the original flight will indeed be unable to accommodate a passenger. For example, assume that because of a flight delay a passenger may, or may not, be able to catch the connecting flight. The original reservation on that connecting flight is considered to be at-risk and will not be cancelled. Instead, it is held for the original passenger. Additionally, the passenger is also booked on another flight so that the passenger has an alternative connection available in the event the original connection is, in fact, missed. When the passenger boards one of these two flights, the other reservation will automatically be cancelled. A determination as to whether a flight is considered at-risk is made using programmable at-risk rules 311.

After the affected bookings are processed, an agent may review one or more of the re-accommodations to ensure they are satisfactory. The re-accommodations that will be reviewed may include those specified by programmable re-booking rules 310, as well as all bookings for which a re-accommodation could not be located. For example, if a passenger is considered to be of “high value” to the airline (e.g., always flies first-class, spends at least a predetermined amount of money with the airline in a predetermined amount of time, etc.), the re-booking information for that passenger may be flagged for manual review to ensure that the re-accommodations are satisfactory for that passenger.

After all affected bookings have been re-accommodated, and if necessary, approved by an airline agent, the results are provided as re-booking data 342 to booking data module 202 for storage in database 108 or some other storage facility. The passengers associated with the bookings are also notified of the re-accommodations. Notification rules 340 define the process that will be used to notify each passenger, using email addresses, phone information, and other personal information stored within customer profile data module 204.

Business rules 302 include other miscellaneous types of rules that are used during the re-booking process. For example, compensation rules 348 are used to determine whether a passenger is to be compensated for inconvenience associated with the re-booking, and if so, what form that compensation should take. Accommodations re-booking rules 350 are provided to define the procedures involved in making lodging, transportation, childcare, and/or other accommodations that are necessitated because of an unexpected layover or the like. Other types of rules may be defined in addition to, or instead of, those shown in FIGS. 3A and 3B.

Re-booking module 116 further includes report generation logic 352 that provides a re-accommodation summary report that lists flights affected by an event, as well as the event type, such as routing change, equipment change, new flight, cancelled flight, and etc. The detailed report provides re-accommodation information for every booking affected by the event. Booking data module 202 also maintains a complete history of all re-booking activities in the respective customer data profiles of those passengers affected by an event.

The above discussion provided an overview of the use of business rules 302. A more detailed discussion is provided in the commonly-assigned patent application entitled “An Airlines Booking System and Method that Utilizes Selectable Business Rules” referenced above.

### III. Description of the User Interface Logic

As discussed above, users interact with RDCS 114 and re-booking module 116 via user interface devices 104A and 104B, which may be personal computers, workstations, terminals, or any other similar devices known in the art. These user interface devices provide functions and display screens in accordance with user interface logic 301 and user interface modules 222, which may be implemented in software, firmware, and/or hardware. User interface modules 222 may includes Active Server Pages, web pages written in HTML or dynamic HTML, Active X modules, Java scripts, Java Applets, Distributed Component Object Modules (DCOM), and the like. Portions of user interface modules 222 may be downloaded as “client-side” user interface logic 301 on user interface devices that are functioning as clients within a client/server environment. In this case, user interface logic 301 may include Active X components or Java scripts executed by web browsers.

User interface logic 301 and user interface modules 222 are designed to provide screens that visually convey to a user the overall flow of the re-booking process and the structure that makes up a RAID. Recall that a RAID is a construct created to track the re-booking activity described above. The screens provided by user interface logic 301 and user interface modules 222 are further designed to guide the user through completing or interacting with the process by linking screens and tasks in a manner that corresponds to the way in which they would most typically be used. Additional navigational links are provided to allow a user to quickly locate and enter information without having to navigate to unnecessary and unrelated screens.

In addition to the foregoing, user interface logic provides a mechanism that allows a user to readily understand how two or more RAIDs are related. As discussed further below, relationships and interdependencies may exist between two or more RAIDs that may not be apparent to a user of the system. Re-booking module 116 and the RAID user interface including user interface logic 301 support a RAID naming convention that allows users to readily comprehend relationships existing in what may be a complex RAID “family tree”. These and other aspects are described further in reference to the remaining drawings.

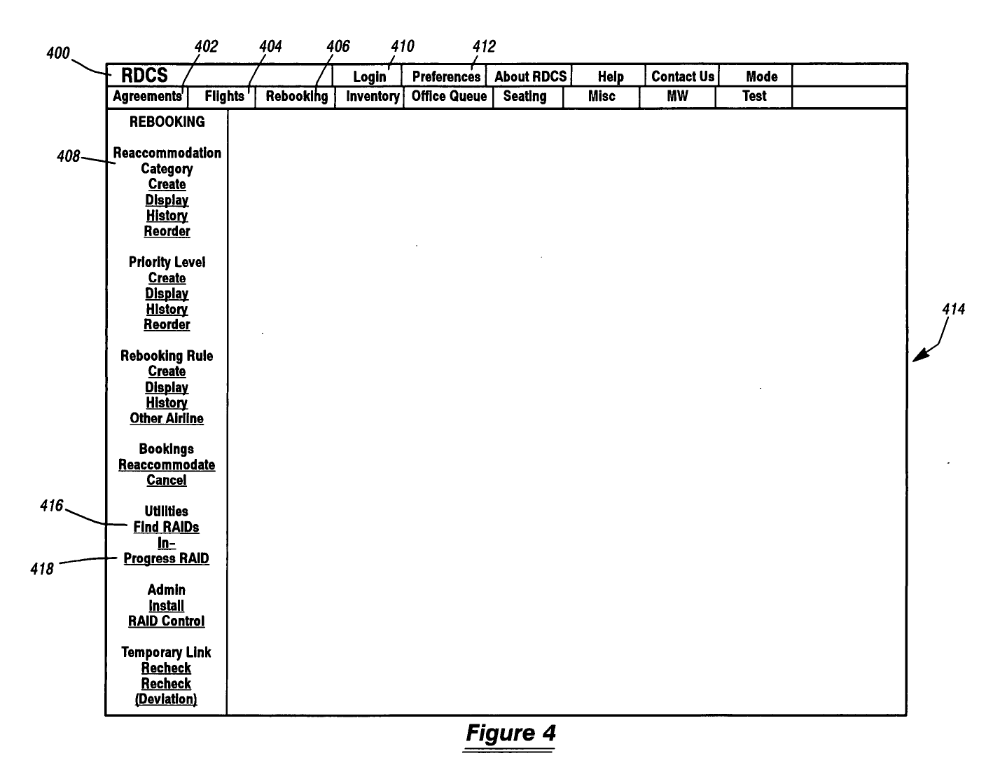

FIG. 4 is a diagram of a screen provided by user interface logic 301 and user interface modules 222 for Reservation and Departure Control System (RDCS) 114. This screen provides user-selectable tabs in screen area 400, including Agreements tab 402, Flights tab 404, Rebooking tab 406, and so on. When one of these tabs is selected, the functions that are supported by the corresponding module are displayed for the user in screen area 408. For example, screen area 408 of FIG. 4 illustrates the functions that are displayed when Rebooking tab 406 is selected. These are the functions supported by Rebooking module 116. In a similar manner, selection of Agreements tab 402 would result in screen area 408 displaying all functions supported by Agreements module 220, and so on.

FIG. 4 also illustrates additional tabs in screen area 400 that are related to system level functions, such as Login tab 410 for logging onto the system, Preferences tab 412 for setting up user preferences, and etc. These functions are not generally applicable to the current invention, and will not be discussed further.

The screen display of FIG. 4 further includes screen area 414. This screen area is populated when one of the functions in screen area 408 is selected. This will be discussed further below. The functions of interest to the current invention include the Find_RAIDs function 416 and the In-Progress_RAID function 418.

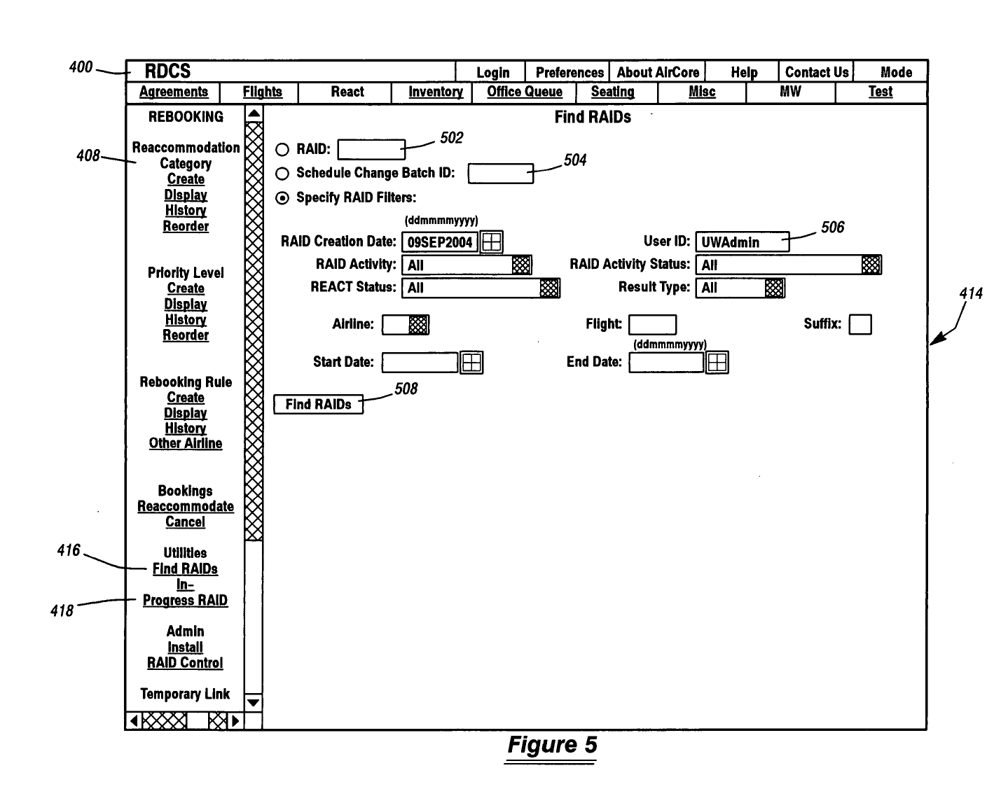

FIG. 5 is a diagram of a screen provided when the Find_RAIDs function 416 of screen area 408 is selected. Activation of this function populates screen area 414 with various input boxes to allow a user to specify information that will identify one or more RAIDs. For example, input box 502 allows a user to specify a RAID by an alphanumeric identifier. Input box 504 allows the RAID to be specified by a schedule change batch ID. Alternatively, or additionally, a filter may be defined by specifying search criteria that will allow the desired RAIDs to be selected. Such criteria includes a creation date, a user ID of the airline agent that defined the RAID, a flight number associated with the RAID, an airline, a start date, and/or an end date. Any of these criteria may be specified to select one or more RAIDs. In the current example, the User ID “UWAdmin” is specified in input box 506 to select all RAIDs defined by the airline agent having this User ID.

When the filter definition is complete, the Find_RAIDs button 508 may be activated to select the desired list of RAIDs.

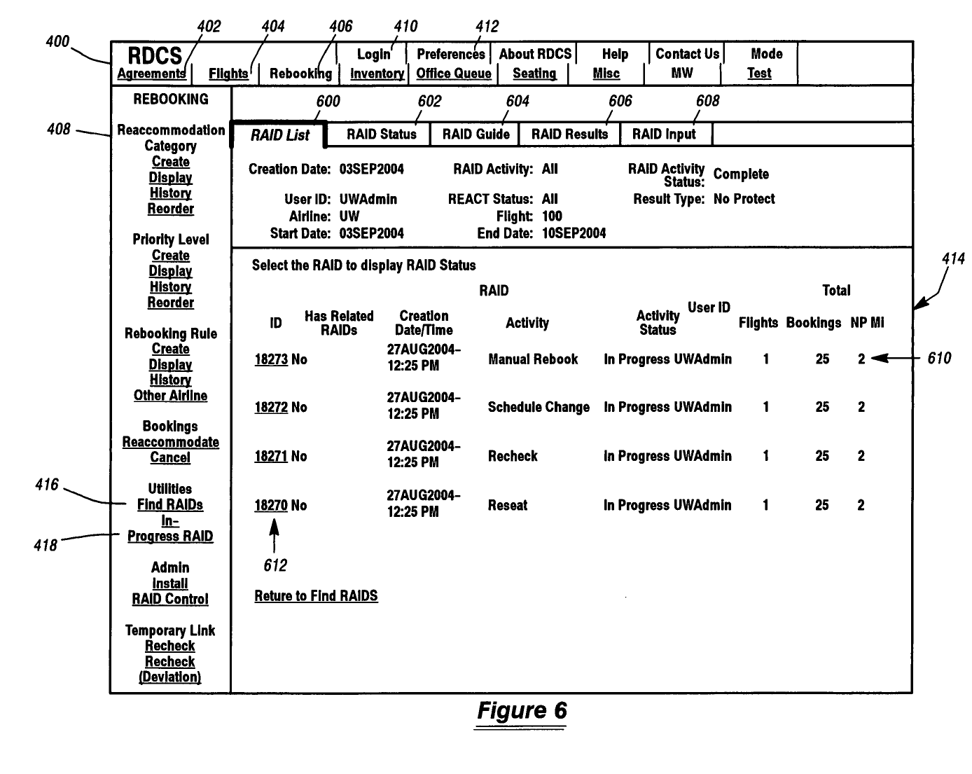

FIG. 6 illustrates a screen provided after the Find_RAIDs button 508 has been activated in the manner discussed above in reference to FIG. 5. In particular, screen area 414 is populated with four selectable function tabs, including RAID_List tab 600, RAID_Status tab 602, RAID_Guide tab 604, RAID Results tab 606, and RAID Input tab 608. These tabs provide high-level RAID functions, as will become apparent below. A user may select any of these tabs using a point-and-click mechanism such as a mouse, or any other mechanism known in the art. For example touch screen technology, voice recognition devices and/or key strokes may be used instead of, or in addition to, the use of a point-and-click mechanism to make the selection.

In FIG. 6, the RAID_List function has been selected, as indicated by the RAID_List tab 600 which is shown in bold. By default, this will be the function initially selected after the Find_RAIDs function 416 is selected in screen area 408. In the current example, selection of this function results in the display of a list of all RAIDs that were defined by the airline agent having a User ID of “UWAdmin”. This list appears in column 612 of screen area 414. Each of the listed RAIDs is identified by an alphanumeric designation. For example, the first listed RAID is assigned the identifier “18273”, and so on. In one embodiment, each of the alphanumeric designators provides a link to another screen containing information for the identified RAID. By selecting a particular designator, as may be accomplished by using conventional “point-and-click” technology to left-click on the designator, or using any other selection mechanism known in the art, the user can navigate to this other screen that is associated with the selected RAID. This is discussed further below.

For each of the listed RAIDS, summary information is provided that includes the time and date the RAID was created, and the type of activity associated with the RAID, such as whether the RAID involves a flight cancellation, a flight schedule change, and etc. The displayed information further includes activity status that indicates whether the RAID is currently in the process of being re-accommodated or whether this process has been completed. As previously described, the RAID is further associated with a User ID that may identify an airlines employee that defined the RAID and that is overseeing the subsequent re-accommodation process. The number of flights associated with the RAID is listed, as are the number of bookings that will be affected. Exemplary information of this nature is shown in row 610 for RAID 18273. Other information may be included instead of, or in addition to, that shown in FIG. 6.

Before considering the screen of FIG. 6 in more detail, the typical flow of events in the re-accommodation process is recapped for discussion purposes. Recall that first a RAID is defined that includes one or more flights that are to be re-accommodated. A guide is then defined that includes the flights that will be considered as alternatives when re-booking is performed for the flights listed in the RAID. After the guide is defined, it may be used to select, for each booking affected by the RAID, one or more flights that best re-accommodates that particular booking. While this re-booking process is occurring, an agent may wish to view the status of the process to see, for example, how many passengers have been successfully re-accommodated thus far for the RAID. When the process is completed, all of the passengers will be successfully re-accommodated, as will be reflected by the re-booking results. If some of the results are unsatisfactory, input may be provided to update the guide to include additional flights, and re-submit some of the bookings for processing against this modified guide.

Each of the above-described tasks within the overall re-booking process is associated with one of function tabs 600-608. For example, the RAID List tab 600 allows a user to view a selected list of defined RAIDs. A RAID status tab 602 provides status for a selected RAID, and may be used by an airlines agent to determine the progress being made to re-accommodate the flight(s) of a given RAID. The RAID Guide tab 604 allows an agent to view, and update, a guide for the selected RAID. The RAID Results tab 606 lists the results of the re-accommodation process for the RAID. Finally, the RAID definition may be viewed using the RAID Input tab 608.

Each of tabs 600-608 is associated with a screen. As already discussed, the screen shown in FIG. 6 is that associated with RAID_List tab 600. A user may navigate to one of the other screens by selecting the desired one of the tabs, as may be accomplished by left-clicking on that tab. For example, a user may navigate to the Status screen by selecting RAID Status tab 602. If navigation occurs by selecting this RAID Status tab, the status screen will display the status for the first RAID In the RAID list of

FIG. 6, which in this case is RAID number 18273. The user may also navigate between screens using links within the screens themselves. For instance, the user may navigate to the Status screen by selecting one of the RAID identifiers in column 612, as by left-clicking on the desired identifier. Each of these identifiers is a link to the Status screen for that RAID. For example, a user may select RAID identifier “18270” to navigate to the Status screen for this RAID.

When a user navigates to the Status screen for a RAID, that RAID becomes the “In-Progress” RAID. This is true whether the user navigates to the screen using the RAID_Status tab, or instead employs the links to select a RAID that is other than the first RAID in the list. The significance of the “In-Progress” RAID is discussed below in reference to a discussion of the In-Progress_RAID function 418.

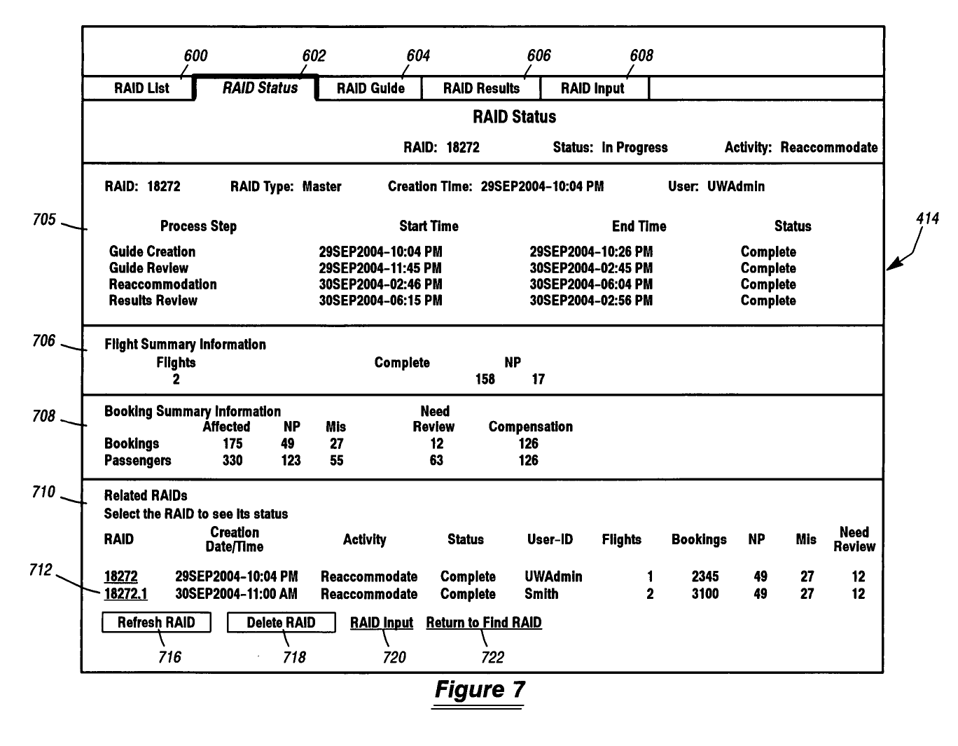

FIG. 7 illustrates the RAID Status screen that may be displayed by selecting the RAID_Status tab 702. For clarity, only screen area 414 is illustrated in FIG. 7, as is also the case in the remaining Figures. However, it will be understood that in a preferred embodiment, the user interface will display screen area 414 along with screen areas 400 and 408, as shown in FIGS. 4 through 6.

As discussed above, the RAID Status screen may be displayed by selecting one of the RAID identifiers within the RAID_List screen (FIG. 6), or by instead selecting RAID Status tab 602. This screen includes status for the selected RAID. In the current example, the status for RAID 18272 is displayed, although status for one of the other RAIDs of FIG. 6 may have been selected instead by selecting the RAID identifier that provides a link to the RAID Status screen, as described above.

The information listed in section 705 of the RAID Status screen includes status data such as when the guide was created for the RAID, when this guide was last reviewed, whether the re-accommodation process has been completed for the RAID, and whether the results have been reviewed by airline personnel. The flight summary information 706 indicates how many flights are included in the RAID. In the instant case, two such flights are included. Bookings summary Information 708 displays the number of bookings and passengers affected by this RAID.

Related RAIDs section 710 illustrates all RAIDs related to the currently selected RAID. In this example, RAID 18272.1 is listed as being related to currently-selected RAID 18272. The way in which RAIDs are related is discussed further below. For the current discussion, it is sufficient to note that when a RAID is created that is related to a previously defined RAID, that newly-created RAID is assigned the same base tag as the earlier created RAID, and is also assigned a unique postfix. For example, since RAID 18272.1 is deemed to be related to RAID 18272, it is assigned the same base tag “18272”, and a unique postfix “.1”. In a similar manner, another subsequently created RAID related to RAID 18272 may be assigned the designator “18272.2”, and so on. The significance of the RAID naming convention is discussed further below.

The screen of FIG. 7 allows users to perform several functions on the selected RAID, including refreshing the RAID so that updated information is shown on the display screen, and deleting the RAID. These functions are performed by activating the Refresh_RAID button 716 and the Delete_RAID button 718, respectively.

The illustrated display screen further includes several links to allow a user to navigate to other related screens. For example, by selecting the RAID_Input link 720, the user navigates to a screen that allows the user to change the RAID definition. That user may, for instance, add flights to the RAID definition. Similarly, selection of the Return_to_Find_RAID link 722 allows the user to navigate back to the screen of FIG. 5.

As was the case with the RAID List screen of FIG. 6, the user may navigate from the RAID Status screen in one of two ways. First, the user may select a different one of tabs 600, or 604-608. By selecting the RAID_Guide tab 604, for example, the user will navigate to the RAID Guide screen for the first RAID listed in screen area 710 of FIG. 7. Similarly, by selecting the RAID_Results tab 606, the user will navigate to the RAID Results screen for this first RAID listed in FIG. 7. Alternatively, a user may navigate between RAID Status screens using links within the screens. For example, when link 712 is selected for RAID 18272.1, the RAID Status screen is displayed for this RAID, and so on.

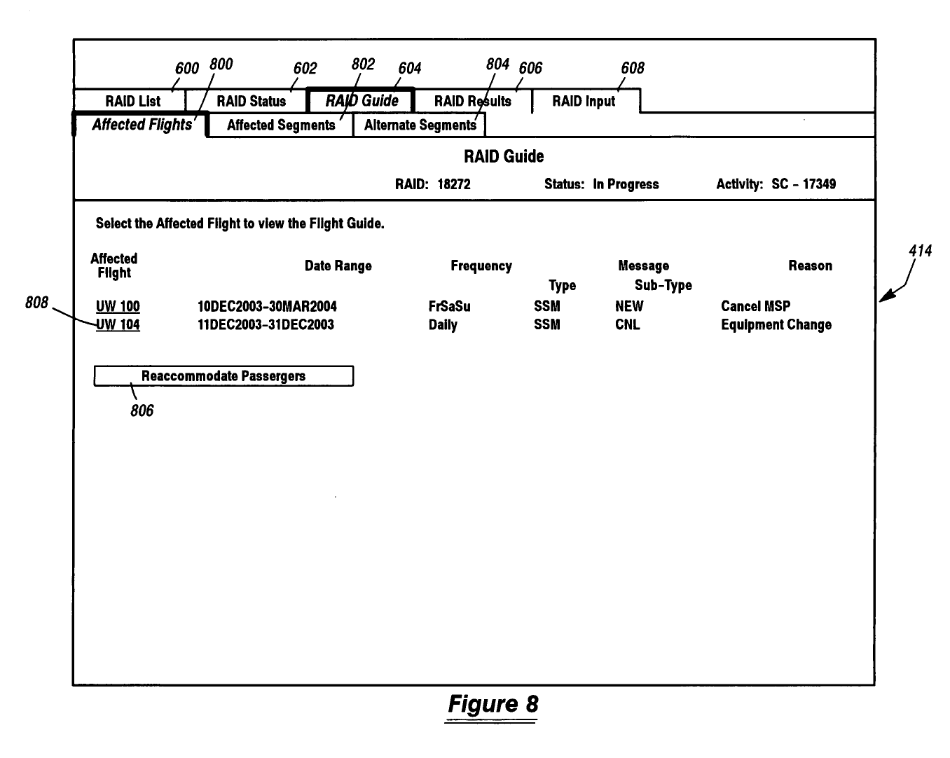

FIG. 8 illustrates the RAID Guide Affected Flights screen that is displayed following selection of RAID Guide tab 604. This screen includes another level of function tabs shown as Affected Flights tab, 800, Affected Segments tab 802, and Alternative Segments tab 804. These tabs are arranged below tab 604 to graphically convey that these are sub-functions of the RAID Guide function. Moreover, they are provided in an ordering that conveys the flow of the process to the user. For example, generally, a user viewing a particular RAID Guide will first want to view the affected flights that are being re-accommodated by the RAID Guide. Next, the user will most often want to obtain a more granular level of detail that includes the segments included within the affected flights. Finally, a user will generally be interested in the flights that have been selected to provide the re-accommodation for the affected segments. This natural flow of events is represented by the left-to-right arrangement of affected flights, affected segments, and alternate segments tabs 800-804, as will be described further below.

When the RAID_Guide tab 604 is first selected, the Affected Flights screen is selected by default, as shown in FIG. 8. This screen illustrates all affected flights that are associated with the given RAID. For each of these flights, information is provided that includes the range of dates associated with the flight, and the frequency, type, and sub-type for the flight. Finally, the reason the flight is being re-accommodated, which may include a flight cancellation, an equipment change, and so on, is listed.

The RAID Guide Affected Flights screen allows a user to activate a Reaccommodate_Passengers function by selecting button 806. This function is used to utilize all alternative flights that are included in the currently-selected RAID Guide to attempt to re-accommodate all passengers on all flights associated with the RAID. For example, in FIG. 8, selection of this function will cause the system to attempt to re-accommodate all passengers that had been booked on flights UW 100 and UW 104 using the Guide for RAID 18272. After this re-accommodation function is selected, the RAID Status screen of FIG. 7 will be displayed so that the user can determine whether the re-accommodation process has completed, and view the booking summary information for the affected passengers.

Links are provided within the screen of FIG. 8 to allow a user to navigate to a more granular level of detail within the RAID Guide function. For example, a user may left-click on flight UW 104, shown as link 808. This will navigate the user to the RAID Guide-Affected Segments_screen for flight UW 104. Alternatively, a user may navigate to this screen using the tabs that are discussed above. That is, by selecting the Affected_Segments tab 802 while the RAID Guide tab 604 remains activated, the user is likewise navigated to the RAID Guide Affected Segments screen. If this latter navigational mechanism is employed such that a tab is selected, the RAID Guide Affected Segments screen, by default, displays information for the first flight listed on the RAID Guide Affected Flights screen, which in this case is flight UW 100.

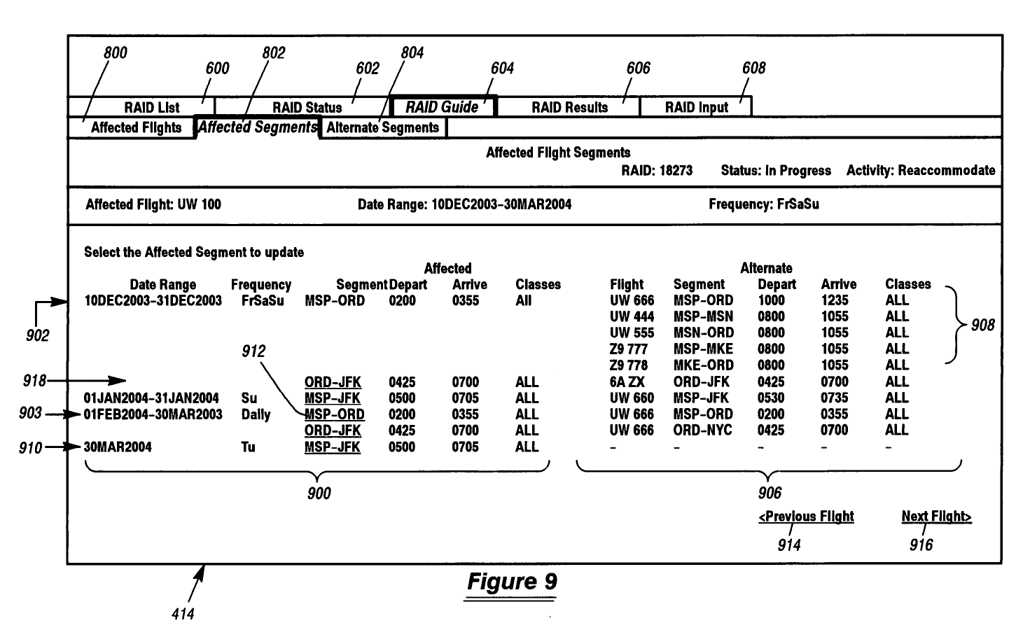

FIG. 9 illustrates the RAID Guide Affected Segments screen for flight UW 100. As described above, a user may navigate to this screen by selection of Affected Segments tab 802 while the RAID Guide tab 604 is activated, or by using the links on the RAID Guide screen of FIG. 8. The Flight Guide screen provides detailed information for each of the segments included in the selected flight, which in this case is flight UW 100.

As may be appreciated by considering the exemplary information for flight UW 100, the segments included within a flight may be different depending on the time of year, and the day of the week, as shown in columns 900. For example, between Dec. 10, 2003 and Dec. 31, 2003, a segment of flight UW 100 departs at 2:00 on Fridays, Saturdays, and Sundays traveling between Minneapolis and Chicago, as shown in row 902. Between Feb. 1, 2004 and Mar. 30, 2003, a similar segment of flight UW 100 departs daily at 2:00 and travels between these two cities, as illustrated in row 903, and so on.

The screen of FIG. 9 further lists the alternative segments that may be used to re-accommodate the passengers that were booked on the affected flight segments. Information for these alternate flights is shown in columns 906. For example, several alternate flights are available to replace the first affected flight segment in row 902. These alternatives, which are listed in rows 908, include a flight UW 666 traveling between Minneapolis and Chicago Ohare. A second alternative includes a first flight from Minneapolis to Madison connecting with a second flight from Madison to Chicago Ohare. A third alternative involves a first flight from Minneapolis to Milwaukee, followed by a connecting flight from Milwaukee to Chicago Ohare. In a similar manner, most of the affected flight segments listed in columns 900 are associated with at least one alternate flight segment listed in columns 906. It may be noted that no alternative flight has been identified by the current guide for the last segment for flight UW 100 shown in row 910.

As was the case with the RAID Guide Affected Flights screen, the current screen allows for easy navigation to the next lower level of detail by selecting one of the affected flight segments. For example, by left-clicking on segment identifier 912 associated with a flight segment from Minneapolis to Chicago Ohare, the user navigates to the RAID Guide Alternate Segments screen for this segment. The user may also navigate to this screen by selecting Alternate_Segments tab 804 while the RAID Guide tab 604 is activated. In this case, the RAID Guide Alternate Segments screen will be displayed for the first segment in the list, which is the segment shown in row 902.

The screen of FIG. 9 includes several additional links that allow for easy navigation between screens. These are shown as the Previous_Flight link 914 and the Next_Flight link 916. By selecting these links, the user navigates to the RAID Guide Affected Segments screen for the previous or next flight associated with the RAID, respectively. For example, assume the user selects the Next_Flight tab 916 in the current illustration. The user will be taken to the RAID Guide Affected Segments screen for the next flight in the current RAID, which is flight UW 104, as listed in the screen of FIG. 8. These additional links allow a user to easily process all of the flights of a Guide without having to return to the RAID Guide Affected Flights screen of FIG. 8 and re-select the next flight in the RAID.

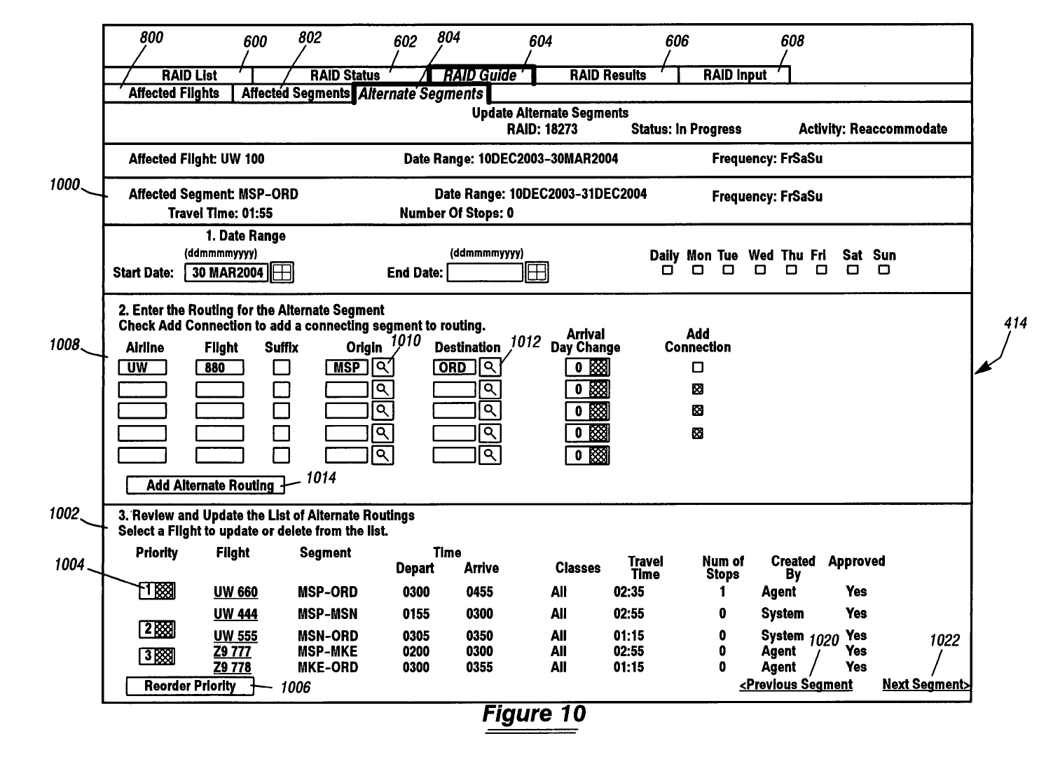

FIG. 10 illustrates the RAID Guide screen for Alternative Segments. As noted above, a user may navigate to this screen using the links embedded within the RAID Guide screen for Affected Segments, or by selecting Alternate_Segments tab 804 after the RAID Guide tab 604 has been selected.

The screen of FIG. 10 allows a user to add flights to the guide for a selected segment, which in the current example is a segment of flight UW 100 traveling between Minneapolis and Chicago on a Friday, Saturday, or Sunday during the last three weeks in December 2004. In particular, screen area 1000 provides general information for the selected segment, including flight days, times, and origin and destination points. Another screen area 1002 further lists alternative flights that may be used to re-accommodate passengers that had been booked on this segment. In the current example, three alternative flight segments have been selected for use in re-accommodating this flight segment, as discussed in reference to FIG. 9. These three alternatives, which are shown in columns 906 of FIG. 9, are also shown in screen area 1002. The first alternative involves a single flight, whereas the second and third alternatives each involves two flights.

As discussed above, the flights in the guide may be ordered in preference of use. This is reflected by the priority field shown in screen area 1002. These priorities may be assigned automatically by the flight availability rules 309A-309C, then updated by an airline agent, if desired. In the current example, the first alternative is assigned the highest, or first, priority using input box 1004. This indicates that this flight segment will be considered first as the possible alternative when re-accommodating a booking for the current affected flight segment. If this first alternative becomes full, or does not satisfy the preferences and/or requirements associated with the booking data, the option with the next highest priority is considered, and so on. The prioritized rankings can be changed at any time by providing a different ranking in the input box and selecting the Reorder_Priority button 1006.

A user has the option of modifying the guide by deleting any of the alternatives listed in screen section 1002, or updating the information associated with any of these alternatives. This can be accomplished by selecting the link associated with the alternative flight number, which opens a respective screen supporting this functionality. For example, a user may left-click on the flight number “UW 660” within screen section 1002 to open a screen that will allow removal of this flight from the guide.

The RAID Guide Alternative Segments screen further includes an additional screen section 1008 to allow a user to add one or more additional alternate segments to the guide. The current display shows flight UW 880 being added as yet another alternative flight segment. During the addition of flight segments, the user may select button 1010 to open a window showing all flights from the origin point, which in this case, is the Minneapolis-St. Paul airport. Similarly, button 1012 may be selected to open a window listing all inbound flights to the destination airport, which in this example is Chicago Ohare. This functionality may be programmably controlled so that only flights from predetermined carriers will be displayed, if desired, as may be controlled by partnership definitions 312 and programmable flight availability rules 309A-309C.

Once flight information has been entered in screen area 1008, the user may select the Add_Alternate_Routing button 1014 to add the alternative flight or flights to the guide. The new alternate segment will then appear in section 1002. The user may thereafter assign a priority to this segment in the manner discussed above.

Several navigational links are available within the screen of FIG. 10. Previous_Segment link 1020 and Next_Segment link 1022 are provided to allow a user to easily navigate to the RAID Guide Alternate Segments screen for the next segment associated with the current RAID. In the current scenario, selecting the Next_Segment link 1022 will allow the current user to navigate to this screen for the next segment of flight UW 100, which is the segment described in row 918 of FIG. 9, and which travels between the Chicago Ohare and the JFK airports. These links are similar to the Previous_Flight link 914 and Next-Flight line 916 of FIG. 9 in that they allow a user to readily process each of the affected segments associated with the selected RAID without having to return to the RAID Guide Affected Segments screen (FIG. 9) to re-select a particular affected segment.

As is evident from the foregoing discussion, the various Affected Flights, Affected Segments, and Alternative Segments tabs are spatially positioned below the RAID Guide tab to indicate that each of these sub-functions is associated with the Guide function. Moreover, the tabs are arranged in a left-to-right order that directs the user naturally through the re-booking process. For example, a user is most likely to start with the highest level of RAID Guide detail, which may be obtained by selecting the left-most Affected Flights tab 800. The user is likely to next desire information pertaining to the specific flight segments that are being re-accommodated. This information is obtained by traversing in a natural left-to-right direction from tab 800 to tab 802. Finally, the most detailed level of information associated with the RAID Guide is obtained by navigating still further right to select the Alternate Segments tab 804. In this manner, the tabs are designed to provide the user with a visual indication of the how the user interface is structured, as well as how the underlying process operates.

The current user interface includes several other features that enhance ease-of-use. First, each of the RAID Guide screens includes links to guide the user from a current screen to a next, more detailed level of information. For example, selecting a link for a flight number within the screen of FIG. 8 navigates the user to the RAID Guide Affected Segments screen for the selected flight (FIG. 9). Similar links move a user from this screen to that of FIG. 10 for a selected flight segment. This corresponds to the way in which users would most likely navigate the screens. Finally, the Previous_Flight and Next_Flight links 914 and 916 (FIG. 9), as well as the Previous_Segment and Next_Segment links 1020 and 1022 (FIG. 10), provide the user with a mechanism to view information for all flights and segments, respectively, of the RAID without changing screens. Using these capabilities, the user may process all information for the RAID while remaining at a currently-selected level of detail. The user need not first navigate to a screen that provides a more general, or more specific, level of detail to obtain the desired information. Thus, the user may view all related information within the RAID at a same selected level of detail without having to unnecessarily traverse the hierarchy of the user interface.

Features similar to those discussed above in reference to the RAID_Guide tab 604 are provided with respect to the various Results screens. These screens are available by selecting the RAID Results tab 606, as discussed below.

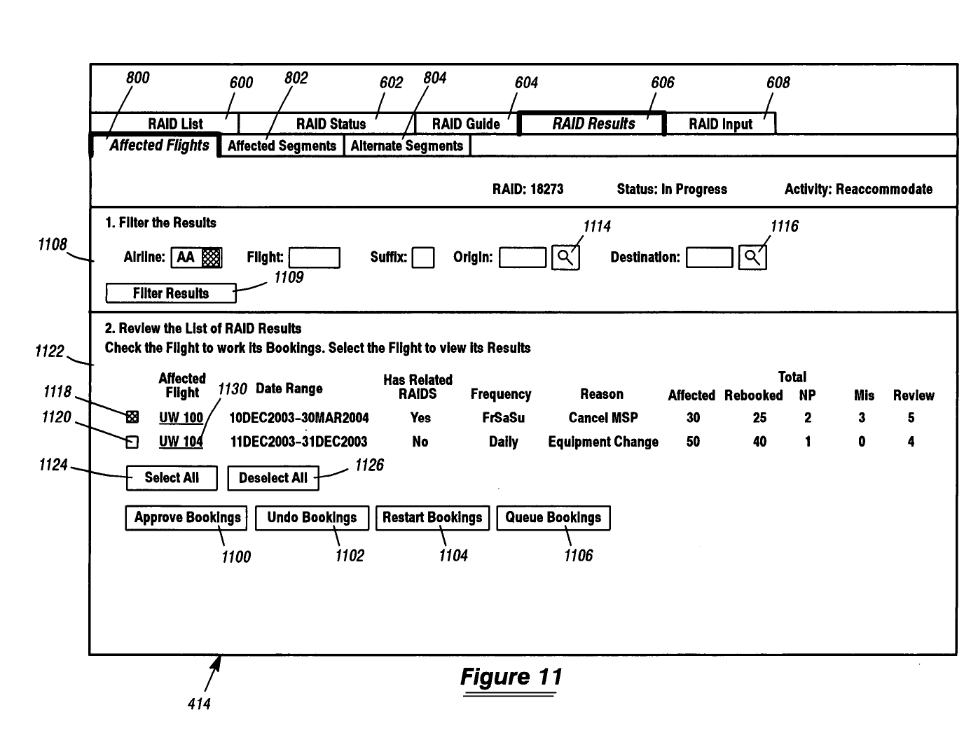

FIG. 11 illustrates a RAID Results screen for Affected Flights that is selected when RAID Results tab 606 is activated. This screen displays a summary of some or all of the re-accommodation results for the selected RAID in a Review Results screen area 1122. This summary information includes the number of bookings affected by a particular flight, as well as the number of these affected bookings that have thus far been re-booked on an alternative flight. A user may then perform a re-booking function on a selected set of the displayed bookings as will be discussed below.

The screen of FIG. 11 provides several functions for selecting particular bookings as follows. First, a filter function is provided to allow a user to work with selected affected flights for the RAID. In the current example, RAID 18272 includes only two flights, UW 100 and UW 104. Information for these flights is shown in Review Results area 1122. However, in some cases, a RAID may be associated with a much larger list of flights, making it difficult to work with all flights at once. In these types of cases, a filter may be defined in screen area 1108 to narrow the list of flights shown in Review Results screen area 1122 to something that is more manageable. For example, the input boxes of the filter screen area 1108 allow a user to select only those flights that have been re-accommodated by a particular airline. The list may be further narrowed by specifying a particular flight number, a flight number suffix, and/or a particular point of origin and/or destination. In one embodiment, the points of origin and destination can be selected using pop-open windows that are activated by choosing buttons 1114 and 1116, respectively. These windows allow the user to easily select from a list of valid origin and departure points. Other criteria may be used instead of, or in addition to, the fields listed for defining the filter.

After the user has defined a filter in screen area 1108, the filter is applied against all flights associated with the RAID by activating the Filter_Results button 1109. When this function is selected, screen area 1122 is re-populated with only those flights selected by the filter. If the user would like to return to a more comprehensive list of flights, the user need only re-select the Filter_Results button 1109 with all fields in screen region 1108 left unspecified.

After the user has obtained the desired subset of flights in the Review Results section 1122, the user may further select a particular one or more of these flights for use in performing a re-booking operation. In the current example, a user may select flights UW 100 and/or UW 104 by selecting the appropriate one or more of input boxes 1118 and 1120, respectively. If desired, bookings for all flights may be selected using the Select_All button 1124. Conversely, the user may de-select bookings for all flights using the Deselect_All button 1126.

In the current case, a user has selected only those bookings associated with cancelled flight UW 100, as indicated by the checkmark in box 1118. Once one or more flights have been selected within screen area 1122 in this manner, the user may utilize buttons 1300-1306 to initiate various operations on these bookings. For example, the user may indicate that the alternative flights that have been booked to re-accommodate the selected flight(s) are to now be approved. This is accomplished by selecting the Approve_Bookings button 1100. Alternatively, the alternative arrangements for the selected bookings may be rejected by selecting the Undo_Bookings button 1102. The Restart_Bookings button 1104 re-applies the currently defined guide to the bookings associated with the selected flights, thereby generating new results. This operation is typically initiated after updating the guide so that different results will be obtained. Finally, the Queue_Bookings button 1106 queues the selected bookings for transfer to a particular airlines agent or office. This may be done for bookings that require special attention, or that must undergo a manual review process, for example.

In the foregoing manner, the RAID Results Affected Flights screen provides an efficient manner to either approve or undo the results for one or more selected bookings. If desired, different results may be generated, or bookings may be queued.

The user may navigate from the screen of FIG. 11 to a more detailed RAID Results screen in one of two ways. The user may select Affected_Segments tab 802 while the RAID Results Tab 606 remains activated. This will navigate the user to the RAID Results Affected Segment screen for the first flight in the list provided in screen area 1122, which in the current example is flight UW 100. Alternatively, the user may select a particular flight from screen area 1122, which will link the user to the respective RAID Results Affected Segments screen for the selected flight. For example, a user may left-click on flight number “UW 104”, 1130, to navigate to the RAID Results Affected Segments screen for this flight. By using the links embedded in screen area 1122 to navigate in this manner, the user is automatically guided from the more general RAID Results screen to the screen containing the next more granular level of detail. The user is not required to necessarily understand how the screens are interrelated, since this navigational functionality is designed to guide the user through the process.

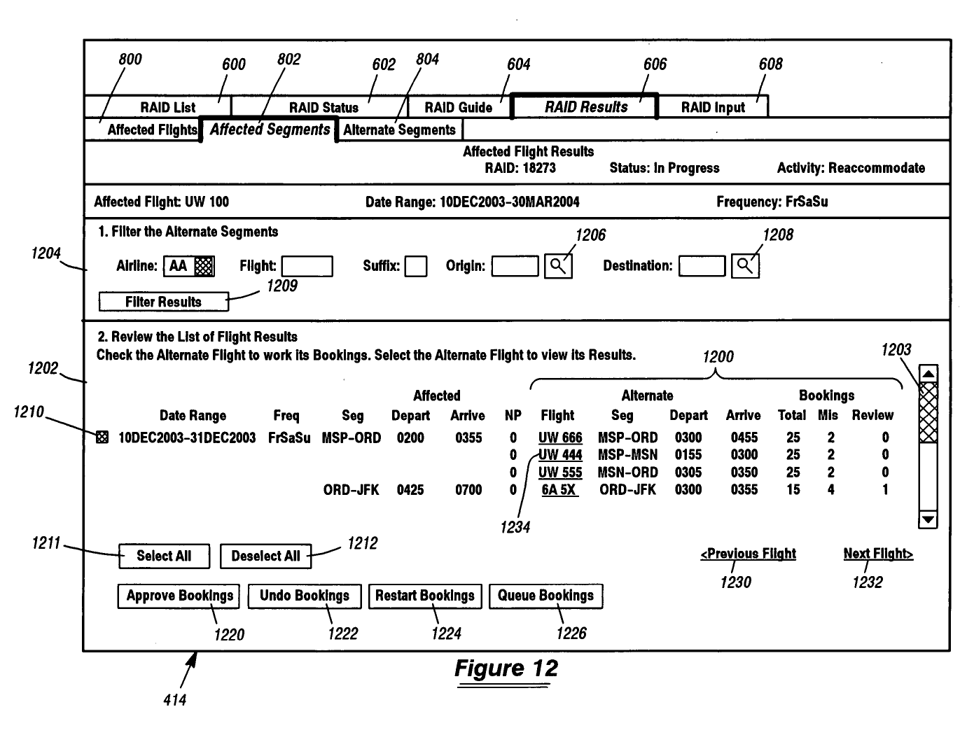

FIG. 12 illustrates the RAID Results screen for Affected Segments. As discussed above, a user may navigate to this screen by selecting a link within the RAID Results screen for Affected Flights, or by using the tabs at the top of the screen. The screen of FIG. 12 allows a user to view, for each segment of the selected flight, the alternative arrangements that have been made for passengers originally booked on that flight. These re-accommodation results are illustrated in columns 1200 of the Review Results screen section 1202. For example, during the time period from Dec. 10, 2003 through Dec. 31, 2003, cancelled flight UW 100 included a segment that had been scheduled to travel between Minneapolis and Chicago Ohare on Friday through Sunday. Flight UW 100 also included another segment from Chicago to New York. For the various bookings that had been associated with these cancelled flight segments, twenty-five of these bookings associated with the Minneapolis/Chicago segment are re-accommodated on flight UW 666, another twenty-five are re-accommodated on two flights, UW 444 and UW 555, and so on. Fifteen of the bookings that had been associated with the Chicago/New York flight segment are re-accommodated on flight 6A 5×. Additional re-accommodations may be displayed by scrolling down with scroll bar 1203.

As was the case with the RAID Results screen of FIG. 11, the user is allowed to select a subset of all of the re-accommodation results for viewing within screen area 1202. This may be useful since the list containing all re-accommodation results may be very large and unwieldy. To view only a limited subset of the re-accommodation results associated with the selected flight, a filter may be defined using the input boxes of screen area 1204. As was the case with the filter function of the RAID Results screen for Affected Flights, a user may utilize the input boxes to specify an airline, flight, flight suffix, point of origin, and/or point of destination. The points of origin and destination may be selected with the help of a pop-open window that is viewable by selecting icons 1206 and 1208. The Filter Results button 1209 is then selected to cause screen area 1202 to be populated with the flight segments selected by the filter.

After screen area 1202 is populated with the re-accommodation results that are of current interest, the user may select a subset of these results on which to perform a booking operation. This selection is accomplished by choosing one or more of the input boxes in screen area 1202. Although only input box 1210 is shown in the current example, additional input boxes may be viewed using scroll bar 1203. Selection or de-selection of all input boxes in screen area 1202 may further be accomplished using the Select_All button 1211 or the Deselect_All button 1212, respectively. In the current example, input box 1210 of screen area 1202 is employed to select all alternative bookings that were originally booked on flight UW 100 during Dec. 10, 2003 through Dec. 31, 2003 from Minneapolis to Chicago, or from Chicago to New York.

Once one or more of the re-accommodation results have been selected within screen area 1202 in the foregoing manner, buttons 1220-1226 may be used to perform various booking operations on these results. These operations are similar to the functions described above with respective to the RAID Results screen for Affected Flights (FIG. 11). For example, by activating Approve_Bookings button 1220, a user may indicate that the alternative flights that have been booked to re-accommodate the selected bookings are to be approved. Alternatively, all of the alternative arrangements for the selected bookings can be rejected by instead selecting the Undo_Bookings button 1222. The Restart_Bookings button 1224 re-applies the currently defined guide to the bookings associated with the flights in the RAID, thereby generating new results for the RAID. This operation is typically initiated after updating the guide so that different results will be obtained. Finally, the Queue_Bookings button 1226 queues the selected bookings for transfer to a particular airlines agent or a particular office. This may be done if the booking requires some special attention, or must undergo a manual review process, for example.

As was the case with the screens discussed above, the screen of FIG. 12 includes links to allow a user to navigate between the flights of the RAID. For example, by selecting the Previous_Flight link 1230, a user may navigate to the RAID Results screen for Affected Flights to display information for a previous flight include in the RAID. Similarly, by selecting the Next_Flight link 1232, a user may readily navigate to the RAID Results screen for Affected Flights to view data for the next flight in the RAID, which in the current example is flight UW 104, as shown in screen area 1122 of FIG. 11. In this manner, a user need not unnecessarily return to the RAID Results screen for Affected Flights, but can remain at the same level of detail within the RAID Results function for each of the flights in the RAID.

The RAID Results screen for Affected Segments further includes additional links to allow the user to navigate to a screen providing more detailed RAID Results, if desired. This can be accomplished by selecting a specific alternative flight segment in columns 1200. For example, by selecting link 1234 for alternative flight segment UW 444 using a left-click operation, the user navigates to the RAID Results Screen for Alternative Segments where information for this selected flight segment is displayed. By linking the screens in this manner, the user is guided from a results screen that provides an overview of the results, to screens providing ever-increasing levels of detail. This follows the process a user would typically employ when viewing the results during re-accommodation operations. Since the links guide the user, the user need not be familiar with the use of the tabs.

Instead of employing the embedded links, a user may navigate to a next level of detail using the tabs. For example, the user may select Alternate_Segments tab 804 while the RAID Results tab 606 remains activated to navigate to the RAID Results screen for Alternate Segments. In this latter case, the RAID Results screen will, by default, display the alternate segment results for the first alternative flight listed in columns 1200, which in this case is UW 666.

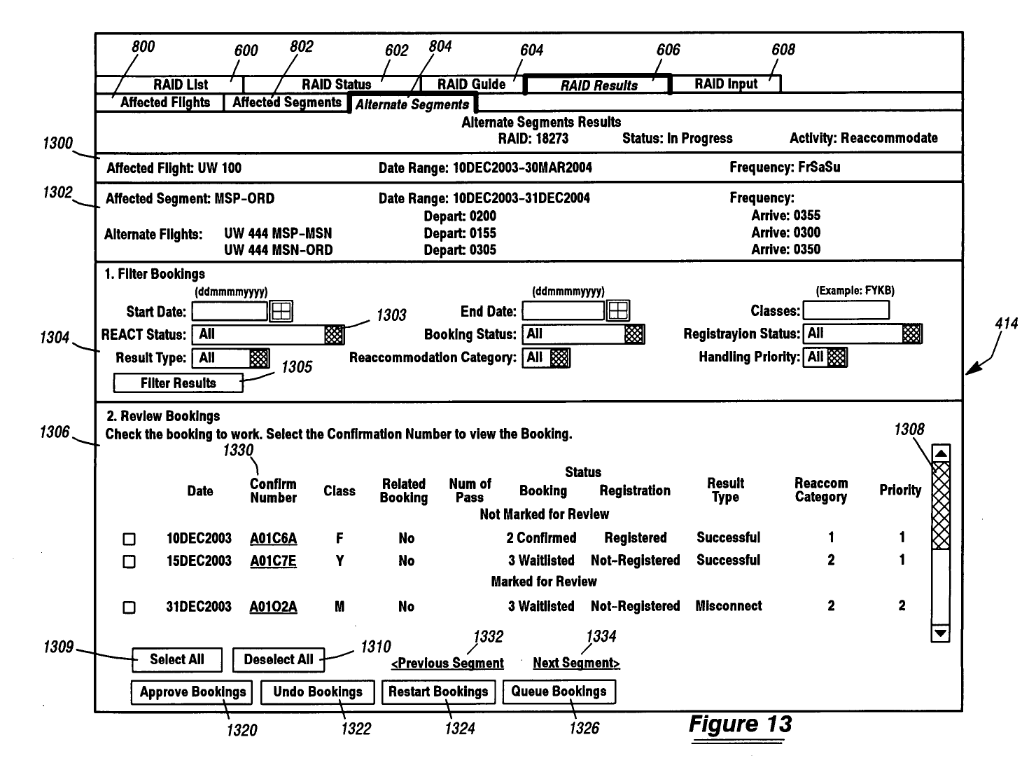

FIG. 13 illustrates the RAID Results screen for Alternate Segments. As previously discussed, this screen may be obtained via the links provided in columns 1200 of the Flight Results screen, or using tabs 606 and 804. This screen provides information regarding all bookings that have been accommodated using a selected alternate flight. The display for this screen is similar to that shown in FIG. 12. The affected flight, which in this example is cancelled flight UW 100, is shown in screen area 1300. Screen area 1302 provides information regarding the selected alternate flight for UW 100, which in this case is UW 444 from Minneapolis to Madison. All bookings for this alternate flight are shown in screen area 1306.

Because the number of bookings associated with the alternate flight may be large, a filter may be defined so that the user may view a selected subset of these bookings. The filter definition is entered using screen area 1304, and may include specified start and end dates, the booking class (e.g., first, business, coach), and various status fields such as the re-booking status, the original booking status, the registration status, and etc. The user may enter any or all of these fields into the appropriate input box. To aid in definition of the filter, the user may view a menu of valid options by selecting a tab to the right of the respective input box. For example, selection of tab 1303 generates a list of all valid REACT status options, and so on.

After a user defines a filter, the Filter_Results button 1305 is selected, causing screen area 1306 to be populated with the desired re-accommodation arrangements for a subset of bookings for the alternate flight segment. The user may return to the entire list by clearing all fields in the filter screen area 1304, then re-selecting the Filter_Results button 1305. In the current case, no filter data has been entered in screen area 1304, and therefore all bookings that had previously been booked on the selected segment of flight UW 100 and that are now booked on UW 444 are displayed in screen area 1306. Screen area 1506 includes scroll bar 1508 to view the complete list of bookings if all selected bookings cannot be viewed within screen area 1306 at once.

Each booking within screen area 1306 is identified via a confirmation number. For each booking, information regarding the booking is provided, including the class for the booking (e.g., first, business, etc.), whether the booking has been successfully re-booked, and whether the one or more passengers associated with the booking have confirmed the rebooking.

The user is allowed to select one or more of the bookings provided in screen area 1306. This can be accomplished by selecting the input boxes next to each of the bookings in the manner discussed above. All of the bookings may be selected using the Select_All button 1309. Similarly, all of the bookings may be de-selected using the Deselect_All button 1310.

Once one or more of the bookings have been selected within screen area 1306, buttons 1320-1326 may be used to perform various operations on the bookings. These operations are similar to the re-booking functions described above with respect to the RAID Results screen for Affected Segments illustrated in FIG. 12. For example, by activating Approve_Bookings button 1320, a user may indicate that each of the selected bookings has been approved. Alternatively, all of these bookings may be rejected by selecting the Undo_Bookings button 1322. The Restart_Bookings button 1324 may be selected to re-apply the currently defined guide to the bookings for flight UW 100, thereby generating new results. Finally, the Queue_Bookings button 1326 queues the selected bookings for processing by a particular individual or office, as discussed above.

Each of the bookings within screen area 1306 is linked to a screen having even more detailed booking information. For example, by selecting confirmation number “A01C6A” in column 1330, the user is directed to a screen including information for this booking, including the name(s) of all passenger(s) associated with the booking, the booking class, booking type, and booking status, and etc.

Additional links 1332 and 1334 are provided to allow the user to navigate between multiple RAID Results screens for Affected Segments. For example, by selecting the Previous_Segment link 1332, the user navigates to the RAID Results screen for Alternate Segments that describes information for the first segment of flight UW 666. Recall that this is the previous flight segment included in the list of re-accommodation segments appearing in columns 1200 of the Flight Results screen (FIG. 12). Similarly, by selecting the Next_Segment link 1334, the user navigates to the RAID Results screen for Alternate Segments for the Madison-to-Ohare segment of flight UW 555. This is the next flight segment listed within columns 1200 of FIG. 12. In this manner, the user is allowed to view the results data for each alternate flight segment associated with cancelled flight UW 100 without having to navigate back to the RAID Results screen for Affected Segments, then re-select a new alternative flight segment.

The function provided to view information associated with the RAID is next described in reference to the RAID_Input tab 608.

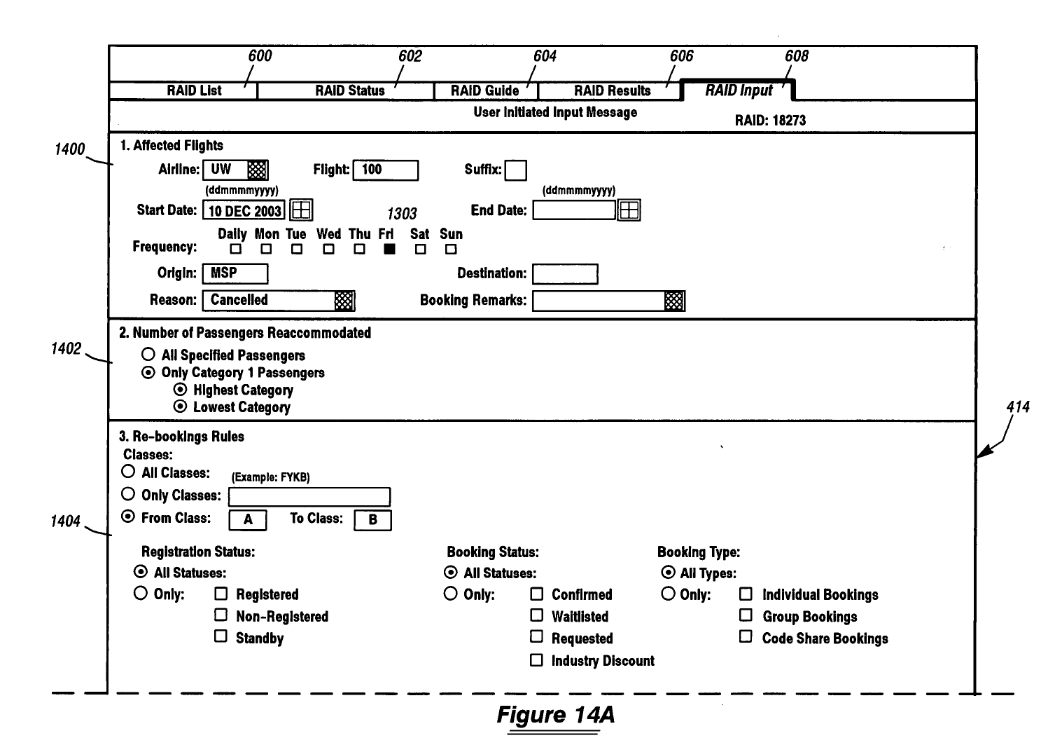

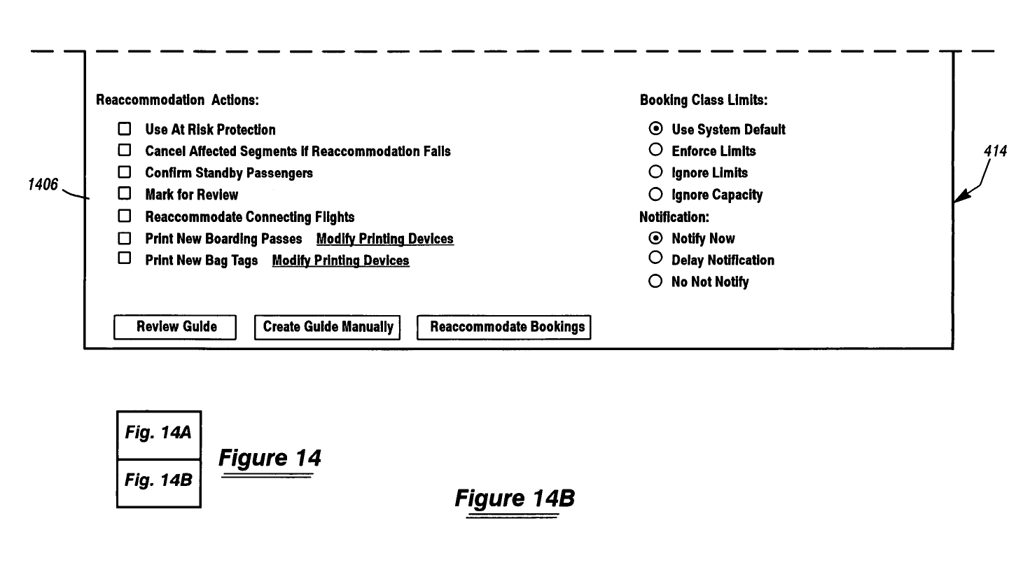

FIGS. 14A and 14B, when arranged as shown in FIG. 14, are a screen that is displayed when the RAID_Input tab 608 is selected. This screen provides information associated with the RAID definition in a read-only format. The provided information may be used by an airline representative to determine why particular results were obtained.

The information displayed when the RAID_Input tab is selected will vary depending on the type of activity associated with the RAID. In the current example, all passengers are being re-accommodated because affected flight UW 100 has been cancelled on Friday Dec. 10, 2003. This may have occurred because of a weather-related event, for example. This flight information is shown in screen area 1400.

Additional information about the re-booking activity is shown in screen area 1402. This screen area describes the number of passengers that were re-accommodated by the RAID. The default situation will re-accommodate all passengers booked on the affected flight. In this default case, this re-accommodation will start with the highest priority category of passengers and proceed to the lowest priority category of passengers in an order determined by the RCL and HPL definitions. The airline agent that is engaged in the re-booking activity can override this default, however. For example, the agent may decide that only certain categories of passengers will be re-accommodated at this time. In this case, the types of passengers actually accommodated by the RAID will be described. Screen area 1402 of the current example shows that only category 1 passengers are being re-accommodated by RAID 18273.

Screen area 1402 may further describe another type of non-standard selection made by the airline agent during the re-booking process. Recall that normally, re-bookings occur starting with the highest priority category and proceeding to the lowest priority category. However, an agent may instead choose to re-book from the lowest to the highest priority category. This may occur, for example, if the re-booking activity is moving some passengers out of first class to less desirable seats. In this latter case, the “lowest category” indicator in screen area 1402 will be highlighted indicating that this non-default situation was selected by the agent. Otherwise, the default situation will be indicated in screen area 1402.

Screen area 1404 indicates any changes made to override the business rules used to rebook the passengers on a different flight. Recall that in the default case, various ones of the business rules 302 may be used to accomplish the rebooking automatically. However, an agent can override these rules if desired. For example, assume that a passenger that would ordinarily be placed on stand-by according to the operation of the business rules is known to have a relative that is very sick. The agent therefore overrides the business rules for this customer. As another example, an agent may decide that the bookings for a particular class of tickets are to be handled in a manner that is different from the way that these bookings would be handled if the pre-defined business rules were executed. Any type of non-standard activity of this nature that is performed to override the business will be reflected in screen area 1404 of the RAID.

In the current example, screen areas 1402 and 1404 indicate that the agent handling RAID 18273 has decided to re-accommodate only the passengers in category 1 that hold class A and class B tickets. In a similar manner, an agent may perform selective re-accommodation by specifying a particular registration status, booking status, and/or booking type using the input boxes of screen area 1404. Only the selected bookings will then be re-accommodated. In the default situation, all classes, statuses, and types will be re-accommodated.

Finally, the portion of the screen shown in FIG. 14B includes screen area 1406, which lists the actions that are taken to re-book and otherwise re-accommodate the passengers. In the default case, these types of re-booking actions are determined by such things as at-risk rules 311, notification rules 340, compensation rules 348, accommodation re-booking rules 350, and operating modes 314. However, these pre-defined business rules may be overridden by the agent overseeing the re-booking process. In the current case, screen area 1406 indicates that the agent did not specify any special re-accommodation actions, and thereby allowed the booking rules to control the re-booking activity. In addition, the system defaults were selected for the booking class limits. These limits determine the number of tickets of a particular class that can be booked on the particular flight. Finally, the “notify now” option has been selected, indicating the passengers are to be notified immediately of the re-accommodation results, rather than being notified at a time determined by notification rules 340.

Next, the assignment of RAID identifiers is discussed in more detail in reference to FIG. 7. As described previously, when a RAID is created that is related to a previously defined RAID, that newly-created RAID is assigned the same designation as the earlier created RAID, and is also assigned a unique postfix. A latter-created RAID is considered related to a previously-defined RAID when that subsequent RAID is necessitated because of an occurrence associated with the previous RAID. For example, assume that flight A is cancelled. When a booking that was originally scheduled on flight A is re-accommodated, assume the alternative flight arrangements are scheduled somewhat later than the original flight A, causing the travelers associated with the booking to miss a connecting flight B. During the re-accommodation process, a RAID having a designation of “5000” is created by RDCS 114 for all bookings associated with flight A. This RAID will be used to re-accommodate the first segment of the exemplary booking. A related RAID may be created to re-accommodate the second segment of the exemplary booking, since that second segment can no longer be scheduled on flight B. This related RAID will be given the same designation “5000” as the parent (original) RAID, but will also be assigned a unique postfix. For example, this related RAID may be named RAID “5000.1”.

Assume further that still another RAID is created that is necessitated because of the flight re-accommodations associated with the second RAID. In the manner discussed above, that third RAID will be assigned the same designation as the second RAID, but will be assigned yet a different postfix. For example, that third RAID may be designated “5000.1.1”, and so on.

Next, assume that yet a fourth RAID must be defined because of the re-booking process associated with the first RAID. This RAID may be designated “5000.2”, because it is the second RAID defined because of dependencies related to the first RAID, and so on. In this way, a “family tree” is created that numbers RAIDs so that it is easy to determine how the various RAIDs are inter-related. An entire family of RAIDs may be displayed by selecting the RAID Status screen (FIG. 7) for the original RAID, which in this case is RAID 5000. All related RAIDs will then appear in the Related RAIDs screen section 710.

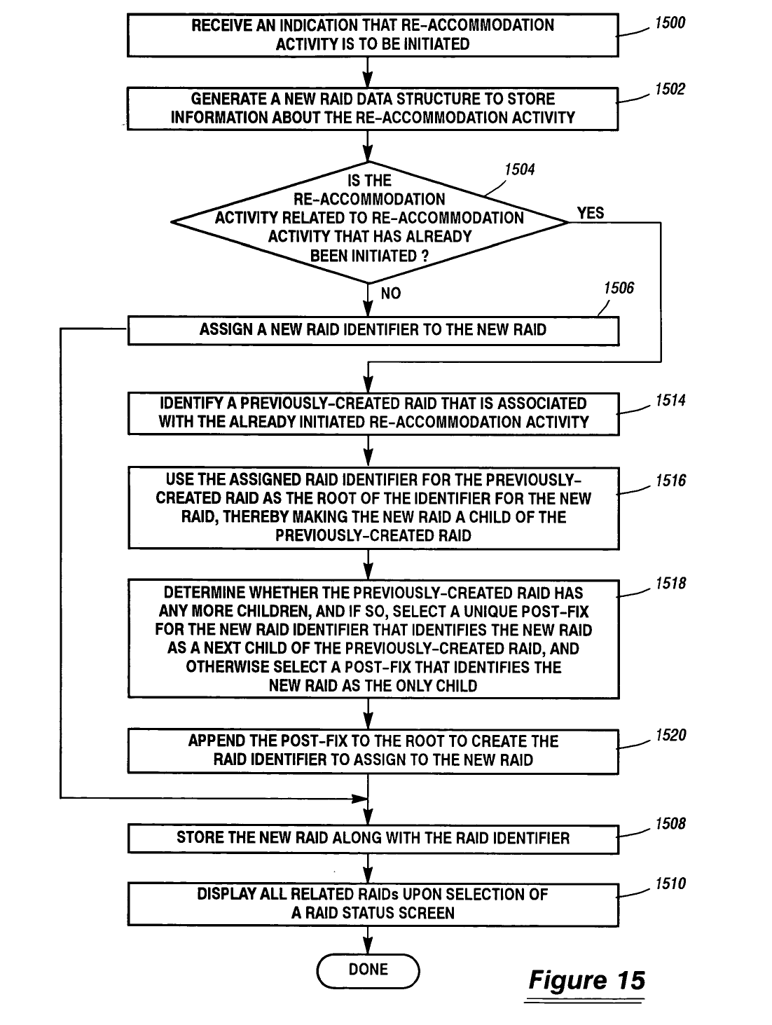

FIG. 15 is a flow diagram illustrating the assigning of RAID identifiers in a manner that allows a user to understand interdependencies existing between the RAIDs. First, RDCS 114 receives an indication that re-accommodation activity is to be invoked (1500). This may occur, for example, by the user selecting the RDCS re-booking function and indicating that a particular flight is cancelled. Next, RDCS 114 creates a new RAID data structure to store information about the re-accommodation activity that will occur to re-book the specified flight (1502). If the current re-accommodation activity is not related to re-accommodation activity that has already been initiated, the system will assign the RAID an identifier in accordance with standard naming conventions (1504). For example, if alphanumeric identifiers are generally assigned to RAIDs in a particular sequence, a next identifier in the sequence will be selected. The new RAID will be stored along with the RAID identifier (1508). This RAID may be referenced using the identifier. After one or more RAIDs are created in this manner, any related RAIDs may be displayed by selecting the RAID Status screen. The related RAIDs appear in the related RAIDs section of this screen, as shown in FIG. 7 and discussed above.

Returning to step 1504, the current re-accommodation activity may be related to re-accommodation activity that has already been initiated. In this case, the airline agent will specify this by entering an indication of the related activity when the current re-accommodation activity is initiated. For instance, the agent may indicate that re-accommodation for the current flight is related to a previous flight delay. The system will then use the information (e.g., flight number of the previous flight as indicated by the agent) to search for, and identify, the previously-created RAID that is associated with the re-accommodation activity for that previous flight (1514). The RAID identifier for this previously-created RAID will be used as a root for the current RAID identifier, thereby establishing a parent/child relationship between the previously-created RAID and the new RAID (1516). It may then be determined whether the parent RAID has any additional children. If so, a post-fix is selected that identifies the current RAID as a next child of the parent RAID. Otherwise, a post-fix is selected that identifies the current RAID as a first (and currently only) child of the parent RAID (1518). As an example, post-fixes may be selected using positive integers that are assigned in the order the children are created. The post-fix may be appended to the root to create the RAID identifier for the new RAID (1520). As an example, if the parent RAID has an identifier of “17A”, the first child may be assigned the identifier of “17A.1”, the second child may be assigned the identifier of “17A.2”, and so on. This allows a user to readily comprehend the way in which one or more RAIDs are related.

After the RAID is created and assigned an identifier in the foregoing manner, the RAID may be stored along with the identifier (1508). The RAID may be referenced by specifying the identifier, as discussed above. Related RAIDs may be viewed by selecting the RAID Status screen of FIG. 7 (1510).

As may be appreciated from the foregoing discussion, the current invention provides a user interface designed to convey the underlying functionality of the system, as well as the process that is supported by that system, to the user. This is accomplished in a number of ways. First, tabs are spatially oriented to convey the hierarchy of the system. For example, five high-level functions exist within the exemplary screens of re-booking system 116. These functions include obtaining a list of RAIDs, viewing the status of a RAID, viewing a guide defined for a RAID, viewing the results obtain when the guide is applied to the bookings for the RAID, and finally, viewing the RAID definition itself. These high-level functions correspond with an associated one of the RAID_List, RAID_Status, RAID_Guide, RAID_Results, and RAID_Input tabs 600-608. These tabs are displayed above the other tabs to indicate that the associated function is a high-level operation.

In addition to the foregoing, tabs 600-608 are arranged in a left-to-right manner that corresponds to a natural process flow. For example, generally a user selects a RAID using the RAID list function. Next, the user will typically view the RAID Status to determine how the re-accommodation process is progressing for the selected RAID. The user will then likely utilize the guide function to view the guide and re-accommodate passengers. Next, status obtained from the re-accommodation process may be viewed using the RAID Results function. Finally, if not all results are satisfactory, the user may utilize the RAID Input screen to analyze the RAID information and determine how the results were achieved. This analysis may be performed in preparation for updating the guide and repeating the process, for example. By selecting the tabs in a left-to-right manner, the user is lead through these steps, and detailed familiarity with the system is not necessarily required to successfully complete the re-accommodation process.

The functionality of the system is further conveyed to the user by positioning tabs related to sub-functions under the high-level tabs. For example, several high-level functions, or steps in the overall process, including those associated with the RAID_Guide and RAID_Results tabs, correspond with lower-level functions, or process steps. These lower-level process steps may be selected using the Affected_Flights, Affected_Segments, and Alternate_Segments tabs 800-804. The hierarchical structure of the system is conveyed to the user by positioning tabs 800-804 under RAID_Guide tab 604 and RAID_Results tab 606.

The left-to-right arrangement of the lower-level tabs 800-804 further conveys the flow of the re-booking process. For instance, it is typical for a user to work from the most general to the most granular level of detail. By selecting tabs 800, 802, and 804 in succession in a typical left-to-right manner, the user is guided from the most high-level screen to the screen containing the most detail.

The inter-screen links also guide the user according to the natural process flow. As discussed above, the screens are linked so that a user may select a specific item for closer viewing. This selection navigates the user to a more detailed view of this item, where the process may be repeated. For example, by selecting a flight within the RAID Guide screen for Affected Flights (FIG. 8), the user is routed to the RAID Guide screen for Affected Segments (FIG. 9). To view even more detailed information, the user may then select a flight segment from the screen of FIG. 9. This will provide a view of all of the alternate flight segments that will be used to re-accommodate passengers originally booked on the selected segment. Thus, the links naturally guide a user according to typical process flow, from a general to a more specific view of selected data.

Screens are also linked to allow a user to remain at the same level of detail. For example, when a user is viewing the RAID Guide screen for Alternate Segments (FIG. 10), the Previous_Segment link 1020 and the Next_Segment link 1022 may be used to obtain this same screen for the other Affected Segments of the RAID. The user need not navigate to the next higher level of detail provided by the RAID Guide Screen for Affected Segments (see FIG. 9) to re-select the segment. This saves time, and facilitates a natural process flow, since often times, once a user has traversed to a particular level of detail, the user is interested in processing all bookings at that detail level. Similar links are provided on the other screens.

The current system and method further allows a user to readily comprehend the way in which RAIDs are related. As discussed above, one or more (child) RAIDs may have an interdependency on a previously-created (parent) RAID, which may, turn, have another interdependency on still an earlier-created RAID. To allow a user to easily visualize the way in which the RAIDs in this family are related, a numbering scheme is utilized that assigns each child RAID the same identifier as its parent, and further assigns a unique post-fix that distinguishes the child from the parent and other children. An entire family of RAIDs may be viewed using the Related RAIDs capability of the RAID Status screen (FIG. 7).

Finally, the current user interface provides an In-Progress_RAID function 418 shown in screen area 408 of FIG. 4. This function is used to allow a user to navigate to the RAID Status screen (FIG. 7) for the RAID that is designated the In-Progress RAID. Recall that when a RAID is selected using the Find_RAIDs function 416, the selected RAID becomes the “In-Progress” RAID. Once a RAID is selected in this manner, it remains the In-Progress RAID until the Find_RAIDs function is again invoked to re-select a new In-Progress RAID.

The In-Progress_RAID function is particularly useful since many RAIDs may be in an incomplete (i.e., in-progress) state within the system at a given time. A RAID is considered incomplete if the associated re-accommodation process has not been finalized. For example, a RAID is incomplete if all bookings affected by the RAID have been re-accommodated, but not all re-accommodations that are flagged for manual review have been approved by an airline agent. A RAID is also considered incomplete if some bookings have yet to be re-accommodated.

During the process of re-accommodating a series of bookings, an agent may have reason to view the data associated with multiple RAIDs. This may be accomplished, for example, using the links provided in screen area 710 of the RAID Status screen (FIG. 7). However, typically during this process, the agent is primarily working on a single RAID that has been selected as being In-Progress using the Find_RAIDs function. Using the In-Progress_RAID function 418, an agent may readily navigate to the RAID status screen for this In-Progress RAID without having to remember the RAID identifier. According to a preferred embodiment, this In-Progress RAID utility is always visible within screen area 408 along with screen areas 400 and 414 to facilitate this navigation.

In accordance with the foregoing, the current invention provides a user interface designed to convey the underlying process supported by the interface. Links between screens are provided to guide the user through the process in an order in which the steps, or functions, would typically be executed. Other links are provided to minimize navigation between hierarchical levels of the screens. For example, within the data stored for a RAID, a hierarchy exists that includes affected flights at a highest level, affected segments at a next lower level, and alternate flights at a lower level. A user may view multiple data instances (e.g., flights or segments) at a selected level in the hierarchy without traversing up or down the hierarchy. This is accomplished by using the “previous” and “next” links provided in some of the screens.

Finally, information tracked by the system is identified using tags or identifiers that allow the user to easily understand interdependencies between this information. It will be understood that while these concepts are utilized within the context of a user interface for a Reservation and Departure Control System for an airline, this interface may be adapted for use with any other type of RDCS used in any transportation industry. Moreover, these concepts may be readily adapted for use in any user interface used to control any process. Such a process may be related to any other data processing application, a manufacturing process, or a process used in yet another environment.

Thus, while various embodiments of the present invention have been described above, it will be understood that they have been presented by way of example only, and not as a limitation. Thus, the breadth and scope of the present invention should not be limited by any of the above-described exemplary embodiments, but should be defined only in accordance with the following Claims and their equivalents.

What is claimed is:

1. An automated method of interacting with a user that is performing a process supported by a Reservation and Departure Control System (RDCS), the method comprising:
a.) providing the capability to generate multiple display screens, each of the display screens for aiding in completion of an associated step in the process, each of the display screens including first screen regions that each corresponds to a respective one of the steps and that are spatially arranged to convey to a user an order in which the steps are typically executed, and wherein selection of any of the first screen regions results in generation of a respective one of the display screens for a currently-selected step; and
ii b.) providing, within at least one of the display screens, multiple second screen regions that are spatially positioned to convey that each of the second screen regions represents a respective sub-step for one or more of the steps, wherein selection of any of the second screen regions results in generation of a respective one of the display screens that aids in completion of the respective sub-step for the currently-selected step.

2. The method of claim 1, wherein the second screen regions are further spatially positioned within the at least one of the display screens so as to convey an order in which the sub-steps are typically performed within the one or more of the steps.

3. The method of claim 1, wherein the second screen regions are further spatially positioned within the at least one of the display screens so as to indicate a level of detail of data that is displayed by each of the respective display screens.

4. The method of claim 1, and further including:
selecting, by a user, one of the second screen regions;
generating a respective display screen for the selected second screen regions, wherein the respective display screen includes multiple selectable instances on which the respective sub-step may be performed;
selecting one of the instances; and
in response to selection of an instance, generating a respective display screen to allow a sub-step that is typically performed next in the process to be executed on the selected instance.

5. The method of claim 1, and further including:
selecting, by a user, one of the second screen regions;
generating a respective display screen for the selected second screen regions, wherein the respective display screen includes multiple selectable instances on which the process may be performed;
selecting one of the instances; and
in response to selection of an instance, generating a respective display screen to allow a user to view a more detailed view of the data associated with that instance.

6. The method of claim 1, wherein the process is managed using data that is organized hierarchically, and further including:
allowing a user to select a level of the hierarchy; and
providing navigational links to allow a user to view all data existing at the selected level of the hierarchy without traversing to a different level in the hierarchy.

7. The method of claim 6, wherein the data is managed using a RAID, and wherein the levels of hierarchy within the RAID include affected flights, affected segments, and alternate segments.

8. The method of claim 1, wherein multiple instances of the process may be executing concurrently, and further including:
allowing a user to identify one of the multiple process instances as the in-progress instance;
allowing a user to view display screens for selected instances of the processes; and
providing a link whereby the user may return to display screens for the in-progress instance without having to identify the in-progress instance.

9. The method of claim 1, wherein multiple instances of the process may be executing, and wherein any instance may be related to one or more other instances, and further including assigning identifiers to the related instances in a manner that indicates how the related instances are related.
